(19) United States
(12) Patent Application Publication
(10) Pub. No.: US 2024/0015784 A1
(43) Pub. Date: Jan. 11, 2024

(54) TECHNIQUES FOR SELECTING A SLICE-BASED RANDOM ACCESS PROCEDURE

(71) Applicant: QUALCOMM Incorporated, San Diego, CA (US)

(72) Inventors: Peng CHENG, Beijing (CN); Linhai HE, San Diego, CA (US); Huilin XU, Temecula, CA (US)

(21) Appl. No.: 18/253,032

(22) PCT Filed: Jan. 8, 2021
(86) PCT No.: PCT/CN2021/070814

§ 371 Date: May 15, 2023

(51) Int. Cl. H04W 74/00; H04W 48/16; H04W 74/08; H04W 48/18

(52) U.S. Cl. CPC H04W 74/006; H04W 48/16; H04W 74/0833; H04W 48/18

(57) ABSTRACT

Methods, systems, and devices for wireless communications are described. A user equipment (UE) may receive a trigger for the UE to perform a RACH procedure to access a network slice (e.g., service). The UE may receive, from a base station, a random access configuration for performance, by the UE, of random access with a physical network. The UE may identify a network slice to be accessed by the UE, where the network slice may be supported by a logical network associated with the physical network. The UE may select a slice-based random access procedure (e.g., two-step slice-based random access procedure, four-step slice-based random access procedure) based on the random access configuration and the network slice to be accessed by the UE. The UE may perform, with the base station, the slice-based RACH procedure in accordance with the selected slice-based RACH procedure type.

### CROSS REFERENCE

The present application is a 371 national stage filing of International PCT Application No. PCT/CN2021/070814 by Cheng et al. entitled “TECHNIQUES FOR SELECTING A SLICE-BASED RANDOM ACCESS PROCEDURE,” filed Jan. 8, 2021, which is assigned to the assignee hereof, and which is expressly incorporated by reference in its entirety herein.

### FIELD OF TECHNOLOGY

The following relates to wireless communications, including techniques for selecting a slice-based random access procedure.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

In some wireless communications systems, a user equipment (UE) may be given access to a slice of a network. That is, a UE may be given access to separate resources within a network that support certain services. However, techniques for the UE to gain access to the cell supporting the network slice may be improved.

### SUMMARY

The described techniques relate to improved methods, systems, devices, and Generally, the described techniques provide for efficient methods for a device (e.g., a user equipment (UE)) to gain access a network slice (e.g., service), such as via a cell supporting the network slice. To gain access to the network slice, the UE may perform a random access channel (RACH) procedure and in some cases, some network slices may be assigned a priority and/or assigned dedicated RACH resources to perform the RACH procedure. For example, a UE may be configured to access an ultra-reliable low-latency (URLLC) network slice, which may be assigned a high priority, or assigned dedicated RACH resource, or both to mitigate latency in gaining access to the URLLC network slice. RACH procedures for gaining access to a network slice, such as a high priority network slice, and/or RACH procedures performed on dedicated RACH resources may be referred to as slice-based RACH procedures (e.g., slice-aware RACH procedures).

For example, a UE may receive a trigger (e.g., arriving traffic, an indication of signals to be transmitted or received by the UE) for the UE to perform a RACH procedure to access a network slice. The UE may receive, from a base station a random access configuration that indicates information related to the RACH procedure, such as information related to a network slice associated with the RACH procedure (e.g., a network slice attempting to be accessed by the RACH procedure), a priority associated with the network slice, a RACH procedure type associated with the network slice, one or more thresholds associated with the network slice (e.g., reference signal received power (RSRP) thresholds, thresholds configured for a fallback procedure), or a combination therefore. The UE may identify a network slice to be accessed by the UE based on the trigger and/or the random access configuration, and select a slice-based random access procedure type (e.g., 2-step slice based random access procedure, 4-step slice based random access procedure) based on the random access configuration and the network slice to be accessed by the UE. The UE may perform, with the base station, the slice-based RACH procedure in accordance with the selected slice-based RACH procedure type.

A method for wireless communications at a user equipment (UE) is described. The method may include receiving, from a base station, a random access configuration for performance, by the UE, of random access with a physical network, identifying a service to be accessed by the UE, the service supported by a logical network associated with the physical network, selecting a service-based random access procedure type based on the random access configuration and the service to be accessed by the UE, and performing a service-based random access procedure in accordance with the service-based random access procedure type.

An apparatus for wireless communications at a UE is described. The apparatus may include a processor, memory in electronic communication with the processor, and instructions stored in the memory. The instructions may be executable by the processor to cause the apparatus to receive, from a base station, a random access configuration for performance, by the UE, of random access with a physical network, identify a service to be accessed by the UE, the service supported by a logical network associated with the physical network, select a service-based random access procedure type based on the random access configuration and the service to be accessed by the UE, and perform a service-based random access procedure in accordance with the service-based random access procedure type.

Another apparatus for wireless communications at a UE is described. The apparatus may include means for receiving, from a base station, a random access configuration for performance, by the UE, of random access with a physical network, means for identifying a service to be accessed by the UE, the service supported by a logical network associated with the physical network, means for selecting a service-based random access procedure type based on the random access configuration and the service to be accessed by the UE, and means for performing a service-based random access procedure in accordance with the service-based random access procedure type.

A non-transitory computer-readable medium storing code for wireless communications at a UE is described. The code may include instructions executable by a processor to receive, from a base station, a random access configuration for performance, by the UE, of random access with a physical network, identify a service to be accessed by the UE, the service supported by a logical network associated with the physical network, select a service-based random access procedure type based on the random access configuration and the service to be accessed by the UE, and perform a service-based random access procedure in accordance with the service-based random access procedure type.

In some examples of the method, apparatuses, and non-transitory computer-readable medium described herein, the service supported by the logical network associated with the physical network may be a network slice, and the service-based random access procedure type may be a slice-based random access procedure type and the service-based random access procedure may be a slice-based random access procedure.

In some examples of the method, apparatuses, and non-transitory computer-readable medium described herein, receiving the random access configuration may include operations, features, means, or instructions for receiving an indication that the network slice may be associated with a priority level, where selection of the slice-based random access procedure type may be based on the priority level of the network slice.

In some examples of the method, apparatuses, and non-transitory computer-readable medium described herein, selecting the slice-based random access procedure type may include operations, features, means, or instructions for determining that the priority level may be greater than a threshold priority level and selecting a two-step slice-based random access procedure as the slice-based random access procedure type based on the priority level being greater than the threshold priority level.

In some examples of the method, apparatuses, and non-transitory computer-readable medium described herein, selecting the slice-based random access procedure type may include operations, features, means, or instructions for determining that the priority level may be less than a threshold priority level and selecting a four-step slide-based random access procedure as the slice-based random access procedure type based on the priority level being less than the threshold priority level.

In some examples of the method, apparatuses, and non-transitory computer-readable medium described herein, receiving the random access configuration may include operations, features, means, or instructions for receiving an indication that the network slice may be associated with a priority level and that the priority level may be associated with a reference signal received power threshold, where selection of the slice-based random access procedure type may be based on the priority level of the network slice and satisfaction of the reference signal received power threshold.

In some examples of the method, apparatuses, and non-transitory computer-readable medium described herein, selecting the slice-based random access procedure type may include operations, features, means, or instructions for determining that a measured reference signal received power may be greater than the reference signal received power threshold and selecting a two-step slice-based random access procedure as the slice-based random access procedure type based on the measured reference signal received power being greater than the reference signal received power threshold.

In some examples of the method, apparatuses, and non-transitory computer-readable medium described herein, selecting the slice-based random access procedure type may include operations, features, means, or instructions for determining that a measured reference signal received power may be less than the reference signal received power threshold and selecting a four-step slice-based random access procedure as the slice-based random access procedure type based on the measured reference signal received power being less than the reference signal received power threshold.

In some examples of the method, apparatuses, and non-transitory computer-readable medium described herein, the priority level may be greater than a threshold priority level.

In some examples of the method, apparatuses, and non-transitory computer-readable medium described herein, receiving the random access configuration may include operations, features, means, or instructions for receiving an indication of a first random access procedure threshold for attempting random access with the physical network using the slice-based random access procedure type.

In some examples of the method, apparatuses, and non-transitory computer-readable medium described herein, the first random access procedure threshold may be a duration of time.

In some examples of the method, apparatuses, and non-transitory computer-readable medium described herein, the first random access procedure threshold may be a number of attempts.

Some examples of the method, apparatuses, and non-transitory computer-readable medium described herein may further include operations, features, means, or instructions for attempting to perform the slice-based random access procedure until the first random access procedure threshold may be satisfied and switching to a common random access procedure based at least in part on satisfaction of the first random access procedure threshold.

In some examples of the method, apparatuses, and non-transitory computer-readable medium described herein, the UE switches to a two-step common random access procedure based on the slice-based random access procedure type being a two-step slice-based random access procedure.

In some examples of the method, apparatuses, and non-transitory computer-readable medium described herein, the UE switches to a four-step common random access procedure based on the slice-based random access procedure type being a four-step slice-based random access procedure.

In some examples of the method, apparatuses, and non-transitory computer-readable medium described herein, receiving the random access configuration may include operations, features, means, or instructions for receiving an indication of a second random access procedure threshold associated with a second slice-based random access procedure type, the slice-based random access procedure type being a first slice-based random access procedure type different from the second slice-based random access procedure type.

Some examples of the method, apparatuses, and non-transitory computer-readable medium described herein may further include operations, features, means, or instructions for attempting to perform random access with the physical network using the first slice-based random access procedure type until satisfaction of the first random access procedure threshold, switching to use of the second slice-based random access procedure type for random access based on satisfaction of the first random access procedure threshold without successful random access using the first slice-based random access procedure type, attempting to perform random access with the physical network using the second slice-based random access procedure type until satisfaction of the second random access procedure threshold, and switching to use of a four-step common random access procedure type for random access based on satisfaction of the second random access procedure threshold without successful random access using the second slice-based random access procedure type, where the first slice-based random access procedure type may be a two-step slice-based random access procedure type and the second slice-based random access procedure type may be a four-step slice-based random access procedure type.

In some examples of the method, apparatuses, and non-transitory computer-readable medium described herein, receiving the random access configuration may include operations, features, means, or instructions for receiving an indication of a second random access procedure threshold associated with a second slice-based random access procedure type and a third random access procedure threshold associated with a two-step common random access procedure type, the slice-based random access procedure type being a first slice-based random access procedure type different from the second slice-based random access procedure type.

Some examples of the method, apparatuses, and non-transitory computer-readable medium described herein may further include operations, features, means, or instructions for attempting to perform random access with the physical network using the first slice-based random access procedure type until satisfaction of the first random access procedure threshold, switching to use of the second slice-based random access procedure type for random access based on satisfaction of the first random access procedure threshold without successful random access using the first slice-based random access procedure type, attempting to perform random access with the physical network using the second slice-based random access procedure type until satisfaction of the second random access procedure threshold, switching to use of the two-step common random access procedure type based on satisfaction of the second random access procedure threshold without successful random access using the second slice-based random access procedure type, attempting to perform random access with the physical network using the two-step common random access procedure type until satisfaction of the third random access procedure threshold, and switching to use of a four-step common random access procedure type for random access based on satisfaction of the third random access procedure threshold without successful random access using the two-step common random access procedure type, where the first slice-based random access procedure type may be a two-step slice-based random access procedure type and the second slice-based random access procedure type may be a four-step slice-based random access procedure type.

In some examples of the method, apparatuses, and non-transitory computer-readable medium described herein, receiving the random access configuration may include operations, features, means, or instructions for receiving an indication of a second random access procedure threshold associated with a two-step common random access procedure type.

Some examples of the method, apparatuses, and non-transitory computer-readable medium described herein may further include operations, features, means, or instructions for attempting to perform random access with the physical network using the slice-based random access procedure type until satisfaction of the first random access procedure threshold, switching to use of the two-step common random access procedure type based on satisfaction of the first random access procedure threshold without successful random access using the slice-based random access procedure type, attempting to perform random access with the physical network using the two-step common random access procedure type until satisfaction of the second random access procedure threshold, and switching to use of a four-step common random access procedure type for random access based on satisfaction of the second random access procedure threshold without successful random access using the two-step common random access procedure type, where the slice-based random access procedure type may be a four-step slice-based random access procedure type.

Some examples of the method, apparatuses, and non-transitory computer-readable medium described herein may further include operations, features, means, or instructions for identifying a second network slice to be accessed by the UE via a second slice-based random access procedure, where the slice-based random access procedure may be a first slice-based random access procedure that may be different from the second slice-based random access procedure, and the network slice may be a first network slice that may be different from the second network slice.

Some examples of the method, apparatuses, and non-transitory computer-readable medium described herein may further include operations, features, means, or instructions for receiving an indication that the first network slice may be associated with a first priority level and the second network slice may be associated with a second priority level.

Some examples of the method, apparatuses, and non-transitory computer-readable medium described herein may further include operations, features, means, or instructions for determining that the first network slice may be of higher priority than the second network slice and suspending the second slice-based random access procedure based on the first network slice having higher priority than the second network slice.

Some examples of the method, apparatuses, and non-transitory computer-readable medium described herein may further include operations, features, means, or instructions for determining that the second network slice may be of higher priority than the first network slice, aborting the first slice-based random access procedure based on the second network slice having higher priority than the first network slice, and performing the second slice-based random access procedure in place of the first slice-based random access procedure.

Some examples of the method, apparatuses, and non-transitory computer-readable medium described herein may further include operations, features, means, or instructions for suspending the second slice-based random access procedure based on the first slice-based random access procedure already being in progress.

In some examples of the method, apparatuses, and non-transitory computer-readable medium described herein, receiving the random access configuration may include operations, features, means, or instructions for receiving at least a portion of the random access configuration in a system information block message.

In some examples of the method, apparatuses, and non-transitory computer-readable medium described herein, receiving the random access configuration may include operations, features, means, or instructions for receiving at least a portion of the random access configuration in a radio resource control message.

### BRIEF DESCRIPTION OF THE DRAWINGS

FIG. 1 illustrates an example of a wireless communications system that supports techniques for selecting a slice-based random access procedure in accordance with aspects of the present disclosure.

FIG. 2 illustrates an example of a wireless communications system that supports techniques for selecting a slice-based random access procedure in accordance with aspects of the present disclosure.

FIG. 3 illustrates an example of a process flow that supports techniques for selecting a slice-based random access procedure in accordance with aspects of the present disclosure.

FIGS. 4 and 5 show block diagrams of devices that support techniques for selecting a slice-based random access procedure in accordance with aspects of the present disclosure.

FIG. 6 shows a block diagram of a communications manager that supports techniques for selecting a slice-based random access procedure in accordance with aspects of the present disclosure.

FIG. 7 shows a diagram of a system including a device that supports techniques for selecting a slice-based random access procedure in accordance with aspects of the present disclosure.

FIGS. 8 through 10 show flowcharts illustrating methods that support techniques for selecting a slice-based random access procedure in accordance with aspects of the present disclosure.

### DETAILED DESCRIPTION

In some wireless communications systems, a user equipment (UE) may be given access to a slice of a network. That is, a UE may be given access to separate resources within a network that supports certain services, such as ultra-reliable low-latency communications (URLLC). To access the network slice, the UE may perform a random access channel (RACH) procedure. In some cases, the UE may perform a slice-based RACH procedure (e.g., slice-aware RACH procedure). In one example of a slice-based RACH procedure, some slices, such as high priority slices (e.g., URLLC), may be configured with a set of RACH resources dedicated for that slice so as to mitigate latency of the slice-based RACH procedure. As such, the UE may perform the slice-based RACH procedure in the dedicated resources associated with the slice the UE is attempting to access. In another example of a slice-based RACH procedure, one or more slices may be assigned a priority, and the slices which are assigned the highest priorities relative to other slices of lower priorities (or of no priority) may be prioritized to use common RACH resources. As such, slice-based RACH procedure may refer to a RACH procedure performed based on slice priority and/or performed in RACH resources dedicated to a slice.

In some implementations, a UE may perform a 2-step slice-based RACH procedure or a 4-step sliced-based RACH procedure. To efficiently select a slice-based RACH procedure type (e.g., 2-step slice-based RACH procedure, a 4-step sliced-based RACH procedure), prior to or upon being triggered to perform a RACH procedure, the UE may receive a RACH configuration message which may indicate information related to the RACH procedure, such as information related to a network slice associated with the RACH procedure (e.g., a network slice attempting to be accessed by the RACH procedure), a priority associated with the network slice, a RACH procedure type associated with the network slice, one or more thresholds associated with the network slice (e.g., reference signal received power (RSRP) thresholds, thresholds configured for a fallback procedure), or a combination therefore. The UE may select a slice-based RACH procedure based on the RACH configuration message. In some implementations, the UE may select the slice-based RACH procedure type based on a common RSRP threshold (e.g., each network slice is associated with the same RSRP threshold). In some implementations, the UE may select the slice-based RACH procedure type based on the priority associated with the network slice. For example, in some cases, network slices may be mapped to a slice-based RACH procedure type based on priority. As such, upon identifying the network slice to be accessed and/or the priority associated with the network slice, the UE may identify the slice-based RACH procedure type based on the network slice and/or priority of the network slice. Additionally or alternatively, network slices may be associated with dedicated RSRP thresholds (e.g., each network slice is assigned an RSRP threshold) based on priority. As such, upon identifying the network slice to be accessed and/or the priority associated with the network slice, the UE may identify the dedicated RSRP threshold associated with the network slice and/or the priority of the network slice and the UE may use the RSRP threshold to determine the slice-based RACH procedure type.

In some implementations, the UE may be configured to perform a fallback procedure in the case that the UE is unable to complete the slice-based random access procedure. For example, the UE may be configured with one or more RACH thresholds (e.g., fallback thresholds), where the UE may attempt to complete the slice-based RACH procedure up to the RACH threshold. The RACH threshold may refer to a number of attempts, or a timer, or both. Upon reaching the RACH threshold and at which point the UE has not successfully completed the slice-based RACH procedure, the UE may be configured to fallback to a common RACH procedure type, or to another slice-based RACH procedure type. In some cases, the UE may be configured to perform multiple fallback procedures until the UE has successfully completed a RACH procure. For example, if the UE fails a first RACH procedure (e.g., by unsuccessfully completing the first RACH procedure before reaching a first RACH threshold) and falls back to a second RACH procedure, the UE may attempt the second RACH procedure (e.g., a common RACH procedure type, or a slice-based RACH procedure type) up to a second RACH threshold, where the first RACH threshold and the second RACH threshold may be the same or different. If the UE reaches the second RACH threshold and has not completed the second RACH procedure, the UE may be configured to fallback to a third RACH procedure, which may be a common RACH procedure type. If the UE is unable to successfully complete the third RACH procedure before reaching a third RACH threshold, the UE may fall back to a fourth RACH procedure.

In some implementations, a UE may receive a second RACH trigger for accessing a second network slice while the UE is performing a first RACH procedure for accessing a first network slice. In some cases, the UE may be configured to refrain from starting the second RACH procedure until the first RACH procedure is complete, where the UE may refrain based on the priority of the first network slice, or a priority of the second network slice, or both. In some cases, a UE may be configured to stop the first RACH procedure and start the second RACH procedure based on the priority of the first network slice, or a priority of the second network slice, or both.

Particular aspects of the subject matter described herein may be implemented to realize one or more advantages. The described techniques may support improvements in performing RACH procedures to access a network slice by improving reliability, and decreasing latency, among other advantages. As such, supported techniques may include improved network operations and, in some examples, may promote network efficiencies, among other benefits.

Aspects of the disclosure are initially described in the context of wireless communications systems. Aspects are then described with reference to a process flow. Aspects of the disclosure are further illustrated by and described with reference to apparatus diagrams, system diagrams, and flowcharts that relate to techniques for selecting a slice-based random access procedure.

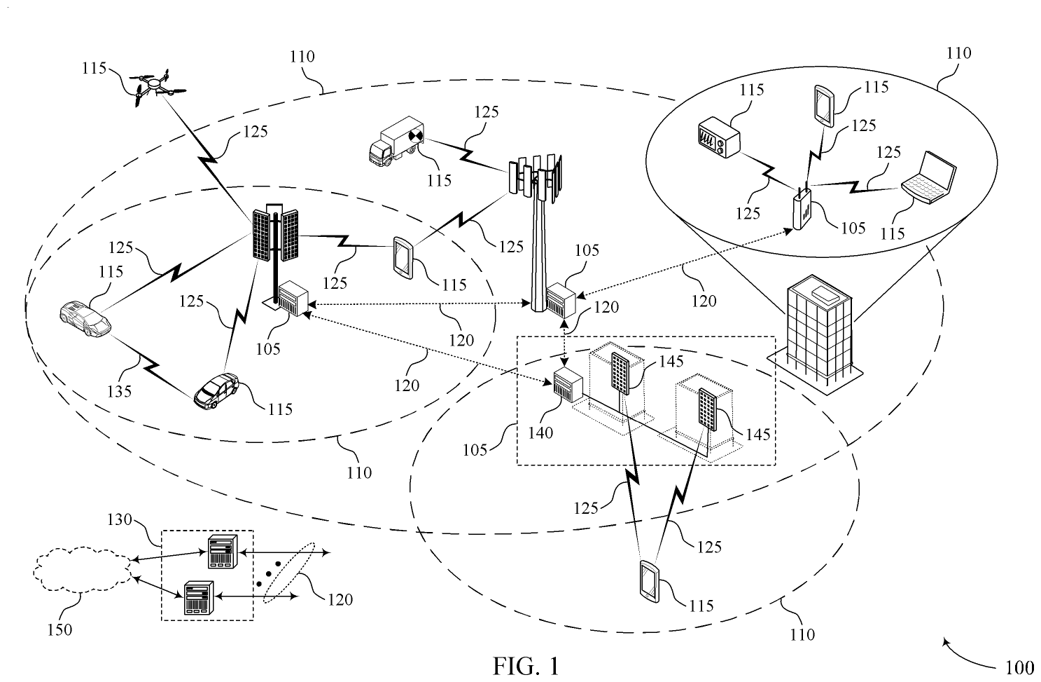

FIG. 1 illustrates an example of a wireless communications system 100 that supports techniques for selecting a slice-based random access procedure in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A UE 115 may receive a trigger (e.g., arriving traffic, an indication of signals to be transmitted or received by the UE 115) for the UE 115 to perform a RACH procedure to access a network slice (e.g., service). The UE 115 may receive, from a base station 105, a random access configuration that indicates information related to the RACH procedure, such as information related to a network slice associated with the RACH procedure (e.g., a network slice attempting to be accessed by the RACH procedure), a priority associated with the network slice, a RACH procedure type associated with the network slice, one or more thresholds associated with the network slice (e.g., reference signal received power (RSRP) thresholds, thresholds configured for a fallback procedure), or a combination therefore. The UE 115 may identify a network slice to be accessed by the UE 115 based on the trigger and/or the random access configuration, and select a slice-based random access procedure type (e.g., 2-step slice based random access procedure, 4-step slice based random access procedure) based on the random access configuration and the network slice to be accessed by the UE 115. The UE 115 may perform, with the base station 105, the slice-based RACH procedure in accordance with the selected slice-based RACH procedure type.

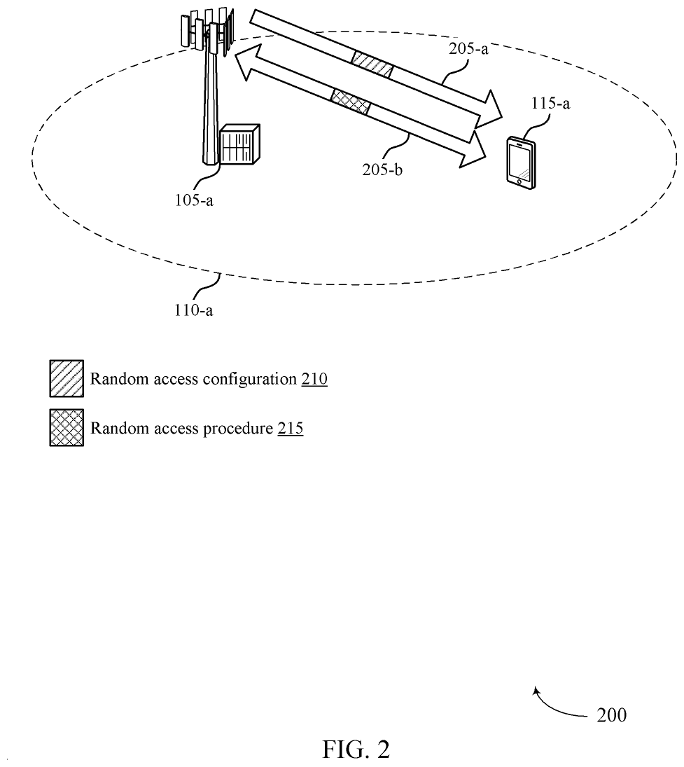

FIG. 2 illustrates an example of a wireless communications system 200 that supports techniques for selecting a slice-based random access procedure in accordance with aspects of the present disclosure. The wireless communications system 200 may include base station 105-a and UE 115-a, which may be examples of a base station 105 and a UE 115 as described with reference to FIG. 1. Base station 105-a may serve a geographic coverage area 110-a. In some cases, UE 115-a may implement a slice-based RACH procedure type selection scheme for performing a RACH procedure. Additionally or alternatively, other wireless devices, such as base station 105-a, may implement a slice-based RACH procedure type selection scheme for performing a RACH procedure.

UE 115-a and base station 105-a may be in communications with one another. For example, UE 115-a may transmit one or more signals to base station 105-a via communication link 205-b, which may be an uplink communications link. In some cases, base station 105-a may transmit signals to UE 115-a via communication link 205-b, which may be a downlink communications link. Additionally or alternatively, base station 105-a may transmit signals to UE 115-a via communications link 205-a, which may be a downlink communications link. For example, UE 115-a may be triggered to perform a RACH procedure and base station 105-a may transmit a message, such as a random access configuration message 210 to UE 115-a. UE 115-a may perform a RACH procedure type selection procedure and perform a random access procedure 215 with base station 105-a in accordance with a selected RACH type. In some cases, UE 115-a may perform the random access procedure 215 to access a network slice (e.g., service, network).

For example, a UE 115 (e.g., UE 115-a) may establish a protocol data unit (PDU) session for a logical data network. The logical data network may also be referred to as a network slice. In some cases, a UE 115 may select a network slice based on an application or subscription service or may receive an indication to select a certain network slice. A network slice may allow UE 115-a access to separate resources within a network that support certain services, such as ultra-reliable low-latency communications (URLLC). Network slices may be determined (e.g., negotiated) during a non-access stratum (NAS) registration procedure. The network (e.g., base station 105-a) may, in some cases, provide network slice selection assistance information (NSSAI) or a set of allowed NSSAIs (S-NSSAI) to the UE 115. The NSSAI may include information indicating allowed or supported network slices for the UE 115 to use, among other information. For example, the allowed NSSAI may include or otherwise refer to requested NSSAI (e.g., or default S-NSSAIs if there is not a valid NSSAI requested), subscribed NSSAI, and current tracking area identity (TAI) supported NSSAI. In some cases, a UE 115 may transmit NSSAI request information (e.g., AS-Requested-NSSAI) to a base station 105 (such as in msg5). In some cases, this requested NSSAI may be used for AMF selection and may be a subset of NAS requested-NSSAI. In some implementations, the network slices supported by a UE 115 may be uniform (e.g., consistent) in a tracking area.

To access the network slice, UE 115-a may perform a RACH procedure. In some cases, the UE may perform a slice-based RACH procedure (e.g., slice-aware RACH procedure). In one example of a slice-based RACH procedure, one or more slices, such as higher priority slices (e.g., URLLC), may be configured with a set of RACH resources (e.g., time and frequency resources) dedicated for that slice so as to mitigate latency of the slice-based RACH procedure. As such, the UE 115 may perform the slice-based RACH procedure in the dedicated resources associated with the slice the UE 115 is attempting to access without contending for use of common RACH resources that other UEs 115 may be using (or attempting to use). In some cases, dedicated resources may be allocated to a network slice of a priority level above a threshold, or to a network slice with latency criterion above a threshold. In some cases, dedicated resources may be allocated to each network slice. Such slice-based RACH procedure may be referred to as RACH resource partitioning and/or RACH resource isolation. In another example of a slice-based RACH procedure, one or more slices may be assigned a priority (e.g., priority level, a priority value, a priority relative to other network slices), and the slices which are assigned the highest priorities relative to other slices of lower priorities (or of no priority) may be prioritized to use common RACH resources. For example, if a first UE 115 is attempting to access a first slice of a high priority and a second UE 115 (e.g., the same UE 115 or a different UE 115 than the first UE 115) is attempting to access a second slice assigned a lower priority than the first slice, the first UE 115 may be configured to use the common RACH resource before the second UE 115 based on the relative priorities of the first and second network slices. Such slice-based RACH procedure may be referred to as parameter prioritization. In some cases, one or more indications (e.g., a preamble ramping step, a back off scaling factor) may be used for prioritized RACH access in one or more procedures, such as handover procedures and beam failure recovery procedures. As such, a slice-based RACH procedure may refer to a RACH procedure performed based on slice priority, or performed in RACH resources dedicated to a certain slice, or both.

In some implementations, UE 115-a may perform a 2-step slice-based RACH procedure or a 4-step sliced-based RACH procedure in accordance with RACH resource partitioning, RACH resource isolation, or parameter prioritization, or a combination thereof. In some cases, UE 115-a may be configured statically, aperiodically, or dynamically with the method for selecting between a 2-step slice-based RACH procedure and a 4-step slice-based RACH procedure. Based on the method of selection UE 115-a is configured to perform, UE 115-a may receive one or more messages from base station 105-a that include RACH information, slice information, etc. For example, UE 115-a may receive, from base station 105-a, a RACH configuration message (e.g., random access configuration 210) which may indicate information related to the RACH procedure, such as information related to a network slice associated with the RACH procedure (e.g., a network slice attempting to be accessed by the RACH procedure), a priority associated with the network slice, a RACH procedure type associated with the network slice, one or more thresholds associated with the network slice (e.g., reference signal received power (RSRP) thresholds, thresholds configured for a fallback procedure), or a combination therefore. In some cases, the RACH configuration message may indicate the method of selection UE 115-a is to perform. UE 115-a may select a slice-based RACH procedure based on the RACH configuration message.

For example, UE 115-a may be triggered to perform a RACH procedure to gain access to a network slice. In some cases, UE 115-a may be triggered by an indication of one or more signals (e.g., traffic) to be transmitted or received by UE 115-a (e.g., triggered by incoming traffic). In some cases, UE 115-a may identify the network slice to be accessed based on the trigger or UE 115-a may receive a separate message, such as the RACH configuration message that indicates the slice to be accessed. Upon being triggered to perform a RACH procedure to gain access to a network slice, UE 115-a may select between the 2-step slice-based RACH procedure and the 4-step slice-based RACH procedure. In some implementations, UE 115-a may be configured to select a slice-based RACH procedure type (e.g., 2-step slice-based RACH procedure, 4-step slice-based RACH procedure) based on a common RSRP threshold. UE 115-a may receive, from base station 105-a, a message that configures the common RSRP threshold (e.g., a single RSRP threshold). The message may indicate the value of the RSRP threshold. The message may be included in the RACH configuration message, or may be a separate message, and may be included in a radio resource control (RRC) message, or synchronization signal block (SIB) message, or both. UE 115-a may identify the common RSRP threshold, and identify one or more RSRP measurements between UE 115-a and base station 105-a, where the one or more RSRP measurements may be based on one or more synchronization signals, or one or more reference signals, or both. UE 115-a may compare one or more of the one or more RSRP measurements, or an average RSRP measurement, to the RSRP threshold. If the RSRP measurement is above the common RSRP threshold, UE 115-a may select the 2-step slice-based RACH procedure. If the RSRP measurement is below the common RSRP threshold, UE 115-a may select the 4-step slice-based RACH procedure. In such a selection of the slice-based RACH procedure, UE 115-a may select the slice-based RACH procedure type irrespective of the network slice.

In some implementations, UE 115-a may be configured to select a slice-based RACH procedure type (e.g., 2-step slice-based RACH procedure, 4-step slice-based RACH procedure) based on information associated with the network slice UE 115-a is to access. UE 115-a may receive, from base station 105-a, a message that indicates one or more slices or one or more priority levels that are associated with the 2-step slice-based RACH procedure, or the message may indicate one or more slices or one or more priority levels that are associated with the 4-step slice-based RACH procedure, or both. The message may be included in the RACH configuration message, or may be a separate message, and may be included in an RRC message, or SIB message, or both. For example, the message may identify certain slices that are associated with the 2-step slice-based RACH procedure, or identify certain slices that are associated with the 4-step slice-based RACH procedure, or both. In some cases, UE 115-a may receive a mapping indicating which slices are associated with which slice-based RACH procedure types, where the mapping may be based on the priority of each network slice. For example, the network slices UE 115-a is allowed to access which are associated with a high priority (e.g., a priority above a threshold) may be included in the mapping, where in some cases, the network slices that meet or exceed the priority threshold may be associated with the 2-step slice-based RACH procedure. As such, the message may indicate the network slices that are above the priority threshold, which may implicitly indicate the network slices that are associated with the 2-step slice-based RACH procedure. In some cases, the message may explicitly indicate that the network slices are associated with the 2-step slice-based RACH procedure, or explicitly indicate that the network slices are associated with the 4-step slice-based RACH procedure. or both. Based on the information included in the message, UE 115-a may identify the slice-based RACH procedure associated with the network slice UE 115-a is attempting to access. For example, UE 115-a may determine whether the network slice UE 115-a is attempting to access is indicated in the message and determine whether the network slice is implicitly or explicitly indicated as being mapped to the 2-step slice-based RACH procedure or the 4-step slice-based RACH procedure. UE 115-a may select the slice-based RACH procedure type based on the mapping of the network slice to a slice-based RACH procedure type.

In another example, the message may implicitly or explicitly identify certain priority levels that are associated with the 2-step slice-based RACH procedure, or identify certain priority that are associated with the 4-step slice-based RACH procedure, or both, where priority levels above a threshold may be associated with the 2-step slice-based RACH procedure. Based on the information included in the message, UE 115-a may identify the slice-based RACH procedure associated with the priority of the network slice UE 115-a is attempting to access. For example, UE 115-a may determine the priority of the network slice UE 115-a is attempting to access and determine whether the determined priority is indicated in the message. UE 115-a may determine whether the determined priority is implicitly or explicitly indicated as being mapped to the 2-step slice-based RACH procedure or the 4-step slice-based RACH procedure and select the slice-based RACH procedure type based on the mapping of the determined priority level a slice-based RACH procedure type.

In some implementations, UE 115-a may be configured to select a slice-based RACH procedure type (e.g., 2-step slice-based RACH procedure, 4-step slice-based RACH procedure) based on information associated with the network slice UE 115-a is to access and based on an RSRP threshold. UE 115-a may receive, from base station 105-a, a message that configures, additionally or alternatively to a common RSRP threshold, one or more dedicated RSRP thresholds. In some cases, dedicated RSRP thresholds may be configured for each network slice, or for network slices that are above a priority threshold. In some cases, dedicated RSRP thresholds may be configured for each network priority level, or for priority levels that are above a priority threshold. The message may be included in the RACH configuration message, or may be a separate message, and may be included in an RRC message, or SIB message, or both. For example, the message include the common RSRP threshold and may map one or more network slices to a dedicated RSRP threshold, where each dedicated RSRP threshold may be different from each other, or may be the same, or partially the same, and each dedicated RSRP threshold may be the same or different from the common RSRP threshold. In some cases, the message may include the value of each dedicated RSRP threshold, or the message may implicitly indicate the value of each dedicated RSRP threshold, where the value may be configured in a lookup table. Upon receiving the message, UE 115-a may determine the network slice UE 115-a is to access, and determine whether the determined network slice is included in the message as being associated with a dedicated RSRP threshold. If the network slice is associated with a dedicated RSRP threshold, UE 115-a may use the dedicated RSRP to select a slice-based RACH procedure. For example, if a measured RSRP between UE 115-a and base station 105-a is less than the dedicated RSRP threshold, UE 115-a may select the 4-step slice-based RACH procedure. If the measured RSRP between UE 115-a and base station 105-a is greater than the dedicated RSRP threshold, UE 115-a may select the 2-step slice-based RACH procedure. In some cases, UE 115-a may fall back to the common RSRP value to select a slice-based RACH procedure. If the network slice is not associated with a dedicated RSRP threshold in the message, UE 115-a may use the common RSRP to select a slice-based RACH procedure, as described herein.

In another example, the message include the common RSRP threshold and may map one or more priority levels to a dedicated RSRP threshold, where each dedicated RSRP threshold may be different from each other, or may be the same, or partially the same, and each dedicated RSRP threshold may be the same or different from the common RSRP threshold. Upon receiving the message, UE 115-a may determine the priority level of the network slice UE 115-a is to access (or determine that the network slice was not assigned a priority level), and determine whether the determined priority level is included in the message as being associated with a dedicated RSRP threshold. If the priority level is associated with a dedicated RSRP threshold, UE 115-a may use the dedicated RSRP to select a slice-based RACH procedure, as described herein. If the priority level is not associated with a dedicated RSRP threshold in the message, or a priority level was not assigned to the network slice, UE 115-a may use the common RSRP to select a slice-based RACH procedure, as described herein.

In some implementations, UE 115-a may be configured to attempt one or more slice-based RACH procedures up to an amount of time, or up to a number of attempts, at which point, if UE 115-a has not successfully completed the slice-based RACH procedure, UE 115-a may be configured to switch (e.g., fallback) to another RACH procedure type. For example, UE 115-a may receive, from base station 105-a, a message that includes one or more RACH thresholds, such as one or more timers (e.g., expiry timers), or one or more number of attempts, or both. For example, a timer may be an amount of time the UE 115 is allotted to perform a successful RACH procedure, and a number of attempts may be the number of times the UE 115 re-start a RACH procedure to perform a successful RACH procedure. In some cases, a RACH threshold may be configured for each RACH type. For example, a first RACH threshold may be associated with a 2-step slice-based RACH procedure, a second RACH threshold may be associated with a 4-step slice-based RACH procedure, a third RACH threshold may be associated with a 2-step common RACH procedure, and a fourth RACH threshold may be associated with a 4-step common RACH procedure. In some cases, a one, common RACH threshold may be configured that may be used for any of the RACH procedure types. The message indicating the one or more RACH thresholds may be included in the RACH configuration message, or may be a separate message, and may be included in an RRC message, or SIB message, or both.

The configuration message may indicate, or UE 115-a may otherwise be configured with a fallback procedure (e.g., configuration). For example, UE 115-a may be configured to fall back from a slice-based RACH procedure to a common RACH procedure of the same type upon reach the RACH threshold. For example, UE 115-a may receive a configuration message that includes one RACH threshold that is associated with the 2-step slice-based RACH procedure, or the 4-step slice-based RACH procedure, or both. The configuration message may indicate, or UE 115-a may otherwise be configured to use the RACH threshold with the 2-step slice-based RACH procedure, or the 4-step slice-based RACH procedure, or both. As such, if UE 115-a attempts to perform the 2-step slice-based RACH procedure, but is unable to complete the procedure before reaching the RACH threshold, UE 115-a may fall back to a 2-step common RACH procedure (e.g., a RACH procedure of the same type). If UE 115-a attempts to perform the 4-step slice-based RACH procedure, but is unable to complete the procedure before reaching the RACH threshold, UE 115-a may fall back to a 4-step common RACH procedure.

In another example, UE 115-a may be configured with a fallback procedure that configures UE 115-a to fall back from a 2-step slice-based RACH procedure, to a 4-step slice-based procedure, to a 4-step common RACH procedure. As such, UE 115-a may receive a configuration message than includes a first RACH threshold, and a second RACH threshold, where the first RACH threshold and the second RACH threshold may be the same or different. The first RACH threshold may be associated with the 2-step slice-based RACH procedure, and the second RACH threshold may be associated with the 4-step slice based RACH procedure. For example, if UE 115-a is configured to attempt to access the network slice with the 2-step slice-based procedure, UE 115-a may attempt to perform a successful 2-step slice-based RACH procedure up to the first RACH threshold. If UE 115-a reaches the first RACH threshold, UE 115-a may fall back to the 4-step slice-based RACH procedure, and UE 115-a may attempt to perform a successful 4-step slice-based RACH procedure up to the second RACH threshold. If UE 115-a reaches the second RACH threshold, UE 115-a may fall back to the 4-step common RACH procedure. In another example, if UE 115-a is configured to attempt to access the network slice with the 4-step slice-based procedure, UE 115-a may attempt to perform a successful 4-step slice-based RACH procedure up to the second RACH threshold and if UE 115-a reaches the second RACH threshold, UE 115-a may fall back to the 4-step common RACH procedure.

In another example, UE 115-a may be configured with a fallback procedure that configures UE 115-a to fall back from a 2-step slice-based RACH procedure, to a 4-step slice-based procedure, to a 2-step common RACH procedure, to a 4-step common RACH procedure. As such, UE 115-a may receive a configuration message than includes a first RACH threshold, a second RACH threshold, and a third RACH threshold, where the first RACH threshold, the second RACH threshold, and the third RACH threshold may be the same or different. The first RACH threshold may be associated with the 2-step slice-based RACH procedure, the second RACH threshold may be associated with the 4-step slice-based RACH procedure, and the third RACH threshold may be associated with the 2-step common RACH procedure. For example, if UE 115-a is configured to attempt to access the network slice with the 2-step slice-based procedure, UE 115-a may attempt to perform a successful 2-step slice-based RACH procedure up to the first RACH threshold. If UE 115-a reaches the first RACH threshold, UE 115-a may fall back to the 4-step slice-based RACH procedure, and UE 115-a may attempt to perform a successful 4-step slice-based RACH procedure up to the second RACH threshold. If UE 115-a reaches the second RACH threshold, UE 115-a may fall back to the 2-step common RACH procedure. UE 115-a may attempt to perform a successful 2-step common RACH procedure up to the third RACH threshold. If UE 115-a reaches the third RACH threshold before successfully performing the 2-step common RACH procedure, UE 115-a may fall back to the 4-step common RACH procedure. UE 115-a may start with any RACH procedure type and perform the fallback configuration accordingly based on the RACH threshold associated with each RACH procedure type.

In some implementations, a UE 115 may be triggered to perform more than one RACH procedure at overlapping times. For example, UE 115-a may be triggered to perform a first RACH procedure to access a first network slice, and UE 115-a may select a RACH procedure type, as described herein, and attempt to perform the selected RACH procedure. While performing the RACH procedure, UE 115-a may be triggered to perform a second RACH procedure to access a second network slice, where the first network slice and the second network slice are different. In some cases, UE 115-a may be configured to suspend the second RACH procedure, until UE 115-a completes the first RACH procedure regardless of the priority of the first network slice or the second network slice. Upon completing the first RACH procedure, UE 115-a may perform the second RACH procedure. In some implementations, UE 115-a may be configured to suspend the second RACH procedure or abort the first RACH procedure based on the priority of the first RACH procedure, or the priority of the second RACH procedure, or both. For example, if the first network slice is associated with a higher priority than the second network slice, then UE 115-a may be configured to suspend the second RACH procedure, until UE 115-a completes the first RACH procedure. Upon completing the first RACH procedure, UE 115-a may perform the second RACH procedure. If the first network slice is associated with a lower priority than the second network slice, then UE 115-a may be configured to abort the first RACH procedure to perform the second RACH procedure. In some cases, upon completing the second RACH procedure, UE 115-a may re-attempt the first RACH procedure.

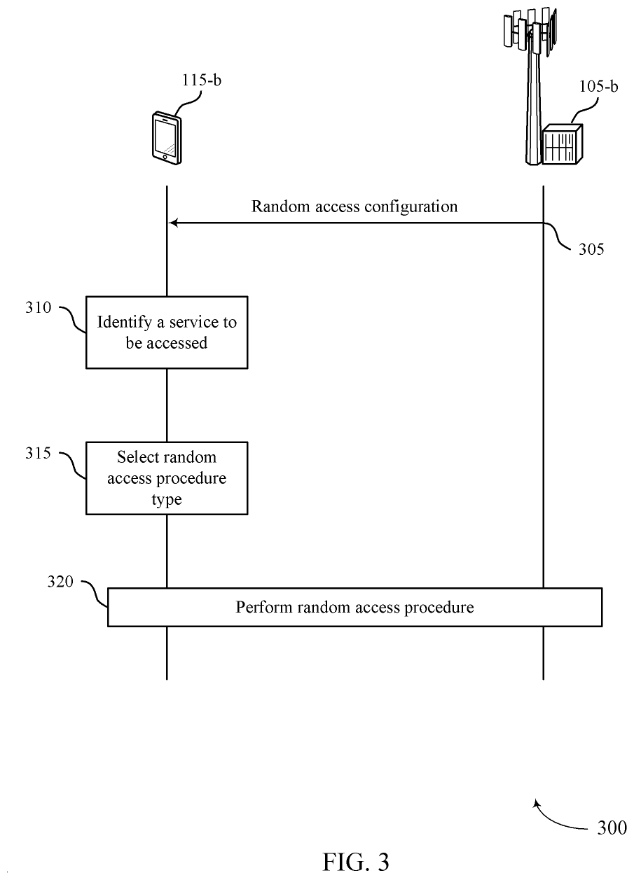

FIG. 3 illustrates an example of a process flow 300 that supports techniques for selecting a slice-based random access procedure in accordance with aspects of the present disclosure. The process flow 300 may illustrate an example RACH procedure type selection scheme for gaining access to a network slice. For example, UE 115-b may perform a selection procedure to select a RACH procedure type for gaining access to a network slice served by base station 105-b. Base station 105-b and UE 115-b may be examples of the corresponding wireless devices described with reference to FIGS. 1 and 2. In some cases, instead of UE 115-b implementing the RACH procedure type selection procedure, a different type of device (e.g., a base station 105) may perform the procedure. Alternative examples of the following may be implemented, where some steps are performed in a different order than described or are not performed at all. In some cases, steps may include additional features not mentioned below, or further steps may be added.

At 305, UE 115-b may receive, from base station 105-b, a random access configuration (e.g., RACH configuration) for performance, by UE 115-b, of random access with a physical network. UE 115-b may receive at least a portion of the random access configuration in a SIB message. UE 115-b may receive at least a portion of the random access configuration in a RRC message.

At 310, UE 115-b may identify a service to be accessed by UE 115-b, the service supported by a logical network associated with the physical network. The service supported by the logical network associated with the physical network may be a network slice.

At 315, UE 115-b may select a service-based random access procedure type (e.g., service-based RACH procedure type) based on the random access configuration and the service to be accessed by UE 115-b. The service-based random access procedure type may be a slice-based random access procedure type. In some cases, UE 115-b may receive (e.g., in the random access configuration) an indication that the network slice is associated with a priority level, where selection of the slice-based random access procedure type may be based on the priority level of the network slice. UE 115-b may determine that the priority level is greater than a threshold priority level, and select a 2-step slice-based random access procedure as the slice-based random access procedure type based on the priority level being greater than the threshold priority level. UE 115-b may determine that the priority level is less than a threshold priority level, and select a 4-step slide-based random access procedure as the slice-based random access procedure type based on the priority level being less than the threshold priority level.

In some cases, UE 115-b may receive an indication that the network slice is associated with a priority level and that the priority level is associated with a reference signal received power threshold, where selection of the slice-based random access procedure type may be based on the priority level of the network slice and satisfaction of the reference signal received power threshold. UE 115-b may determine that a measured reference signal received power is greater than the reference signal received power threshold, and select a 2-step slice-based random access procedure as the slice-based random access procedure type based on the measured reference signal received power being greater than the reference signal received power threshold. UE 115-b may determine that a measured reference signal received power is less than the reference signal received power threshold, and select a 4-step slice-based random access procedure as the slice-based random access procedure type based on the measured reference signal received power being less than the reference signal received power threshold. The priority level may be greater than a threshold priority level.

At 320, UE 115-b may perform a service-based random access procedure in accordance with the service-based random access procedure type. The service-based random access procedure may be a slice-based random access procedure. In some cases, UE 115-b may receive (e.g., with the RACH configuration) an indication of a first random access procedure threshold for attempting random access with the physical network using the slice-based random access procedure type. The first random access procedure threshold may be a duration of time, or a number of attempts. UE 115-b may attempt to perform the slice-based random access procedure until the first random access procedure threshold is satisfied, and switch to a common random access procedure based at least in part on satisfaction of the first random access procedure threshold. UE 115-b may switch to a 2-step common random access procedure based on the slice-based random access procedure type being a 2-step slice-based random access procedure. UE 115-b may switch to a 4-step common random access procedure based on the slice-based random access procedure type being a 4-step slice-based random access procedure.

In some cases, UE 115-b may receive (e.g., with the RACH configuration) an indication of a second random access procedure threshold associated with a second slice-based random access procedure type, where the slice-based random access procedure type may be a first slice-based random access procedure type different from the second slice-based random access procedure type. UE 115-b may attempt to perform random access with the physical network using the first slice-based random access procedure type until satisfaction of the first random access procedure threshold, and switch to use of the second slice-based random access procedure type for random access based on satisfaction of the first random access procedure threshold without successful random access using the first slice-based random access procedure type. UE 115-b may attempt to perform random access with the physical network using the second slice-based random access procedure type until satisfaction of the second random access procedure threshold, and switch to use of a 4-step common random access procedure type for random access based on satisfaction of the second random access procedure threshold without successful random access using the second slice-based random access procedure type. The first slice-based random access procedure type may be a 2-step slice-based random access procedure type and the second slice-based random access procedure type may be a 4-step slice-based random access procedure type.

In some cases, UE 115-b may receive (e.g., with the RACH configuration) an indication of a second random access procedure threshold associated with a second slice-based random access procedure type and a third random access procedure threshold associated with a 2-step common random access procedure type, where the slice-based random access procedure type may be a first slice-based random access procedure type different from the second slice-based random access procedure type. UE 115-b may attempt to perform random access with the physical network using the first slice-based random access procedure type until satisfaction of the first random access procedure threshold; and switch to use of the second slice-based random access procedure type for random access based on satisfaction of the first random access procedure threshold without successful random access using the first slice-based random access procedure type. UE 115-b may attempt to perform random access with the physical network using the second slice-based random access procedure type until satisfaction of the second random access procedure threshold, and switch to use of the 2-step common random access procedure type based on satisfaction of the second random access procedure threshold without successful random access using the second slice-based random access procedure type. UE 115-b may attempt to perform random access with the physical network using the 2-step common random access procedure type until satisfaction of the third random access procedure threshold, and switch to use of a 4-step common random access procedure type for random access based on satisfaction of the third random access procedure threshold without successful random access using the 2-step common random access procedure type. The first slice-based random access procedure type may be a 2-step slice-based random access procedure type and the second slice-based random access procedure type may be a 4-step slice-based random access procedure type.

In some cases, UE 115-b may receive (e.g., with the RACH configuration) an indication of a second random access procedure threshold associated with a 2-step common random access procedure type. UE 115-b may attempt to perform random access with the physical network using the slice-based random access procedure type until satisfaction of the first random access procedure threshold, and switch to use of the 2-step common random access procedure type based on satisfaction of the first random access procedure threshold without successful random access using the slice-based random access procedure type. UE 115-b may attempt to perform random access with the physical network using the 2-step common random access procedure type until satisfaction of the second random access procedure threshold, and switch to use of a 4-step common random access procedure type for random access based on satisfaction of the second random access procedure threshold without successful random access using the 2-step common random access procedure type. The slice-based random access procedure type may be a 4-step slice-based random access procedure type.

In some implementations, UE 115-b may identify a second network slice to be accessed by UE 115-b via a second slice-based random access procedure, where the slice-based random access procedure may be a first slice-based random access procedure that is different from the second slice-based random access procedure. The network slice may be a first network slice that is different from the second network slice. UE 115-b may receive an indication that the first network slice is associated with a first priority level and the second network slice is associated with a second priority level. UE 115-b may determine that the first network slice is of higher priority than the second network slice, and suspend the second slice-based random access procedure based on the first network slice having higher priority than the second network slice. UE 115-b may determine that the second network slice is of higher priority than the first network slice, abort the first slice-based random access procedure based on the second network slice having higher priority than the first network slice, and perform the second slice-based random access procedure in place of the first slice-based random access procedure. UE 115-b may suspend the second slice-based random access procedure based on the first slice-based random access procedure already being in progress.

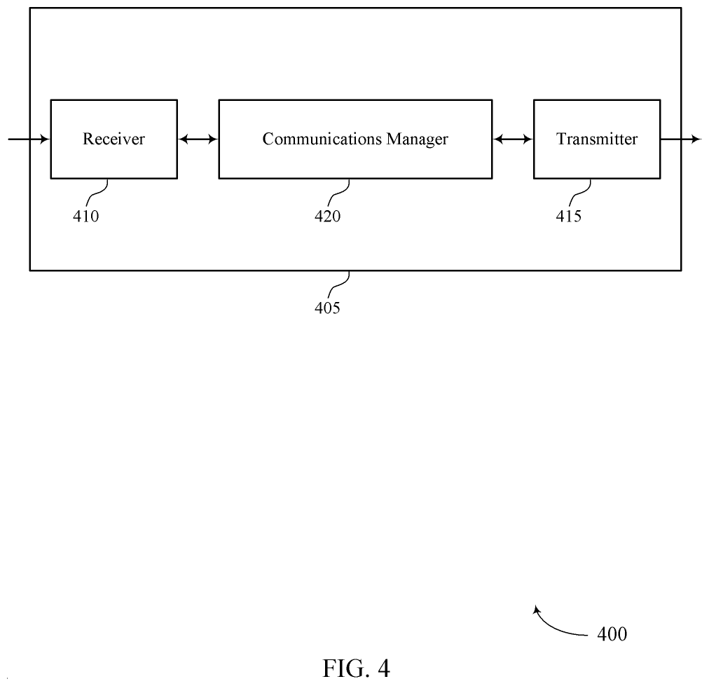

FIG. 4 shows a block diagram 400 of a device 405 that supports techniques for selecting a slice-based random access procedure in accordance with aspects of the present disclosure. The device 405 may be an example of aspects of a UE 115 as described herein. The device 405 may include a receiver 410, a transmitter 415, and a communications manager 420. The device 405 may also include a processor. Each of these components may be in communication with one another (e.g., via one or more buses).

The receiver 410 may provide a means for receiving information such as packets, user data, control information, or any combination thereof associated with various information channels (e.g., control channels, data channels, information channels related to techniques for selecting a slice-based random access procedure). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to techniques for selecting a slice-based random access procedure). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations thereof or various components thereof may be examples of means for performing various aspects of techniques for selecting a slice-based random access procedure as described herein. For example, the communications manager 420, the receiver 410, the transmitter 415, or various combinations or components thereof may support a method for performing one or more of the functions described herein.

In some examples, the communications manager 420, the receiver 410, the transmitter 415, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 420, the receiver 410, the transmitter 415, or various combinations or components thereof may be implemented in code (e.g., as communications management software or firmware) executed by a processor. If implemented in code executed by a processor, the functions of the communications manager 420, the receiver 410, the transmitter 415, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 420 may be configured to perform various operations (e.g., receiving, monitoring, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to receive information, transmit information, or perform various other operations as described herein.

The communications manager 420 may support wireless communications at a UE in accordance with examples as disclosed herein. For example, the communications manager 420 may be configured as or otherwise support a means for receiving, from a base station, a random access configuration for performance, by the UE, of random access with a physical network. The communications manager 420 may be configured as or otherwise support a means for identifying a service to be accessed by the UE, the service supported by a logical network associated with the physical network. The communications manager 420 may be configured as or otherwise support a means for selecting a service-based random access procedure type based on the random access configuration and the service to be accessed by the UE. The communications manager 420 may be configured as or otherwise support a means for performing a service-based random access procedure in accordance with the service-based random access procedure type.

By including or configuring the communications manager 420 in accordance with examples as described herein, the device 405 (e.g., a processor controlling or otherwise coupled to the receiver 410, the transmitter 415, the communications manager 420, or a combination thereof) may support techniques for more efficient utilization of communication resources.

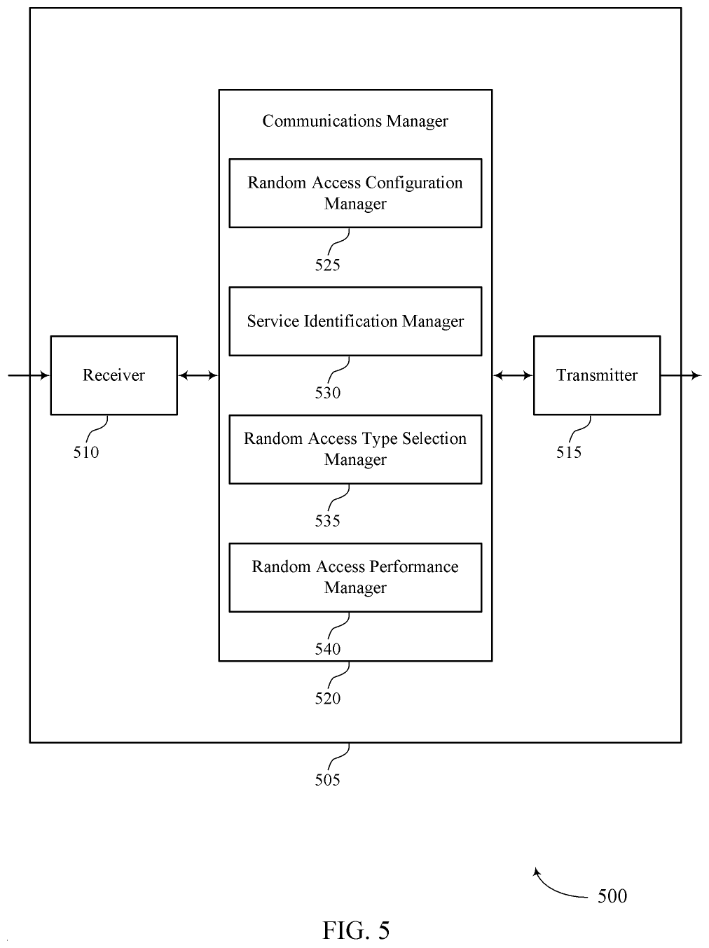

FIG. 5 shows a block diagram 500 of a device 505 that supports techniques for selecting a slice-based random access procedure in accordance with aspects of the present disclosure. The device 505 may be an example of aspects of a device 405 or a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for selecting a slice-based random access procedure). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for selecting a slice-based random access procedure). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of techniques for selecting a slice-based random access procedure as described herein. For example, the communications manager 520 may include a random access configuration manager 525, a service identification manager 530, a random access type selection manager 535, a random access performance manager 540, or any combination thereof. The communications manager 520 may be an example of aspects of a communications manager 420 as described herein. In some examples, the communications manager 520, or various components thereof, may be configured to perform various operations (e.g., receiving, monitoring, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to receive information, transmit information, or perform various other operations as described herein.

The communications manager 520 may support wireless communications at a UE in accordance with examples as disclosed herein. The random access configuration manager 525 may be configured as or otherwise support a means for receiving, from a base station, a random access configuration for performance, by the UE, of random access with a physical network. The service identification manager 530 may be configured as or otherwise support a means for identifying a service to be accessed by the UE, the service supported by a logical network associated with the physical network. The random access type selection manager 535 may be configured as or otherwise support a means for selecting a service-based random access procedure type based on the random access configuration and the service to be accessed by the UE. The random access performance manager 540 may be configured as or otherwise support a means for performing a service-based random access procedure in accordance with the service-based random access procedure type.

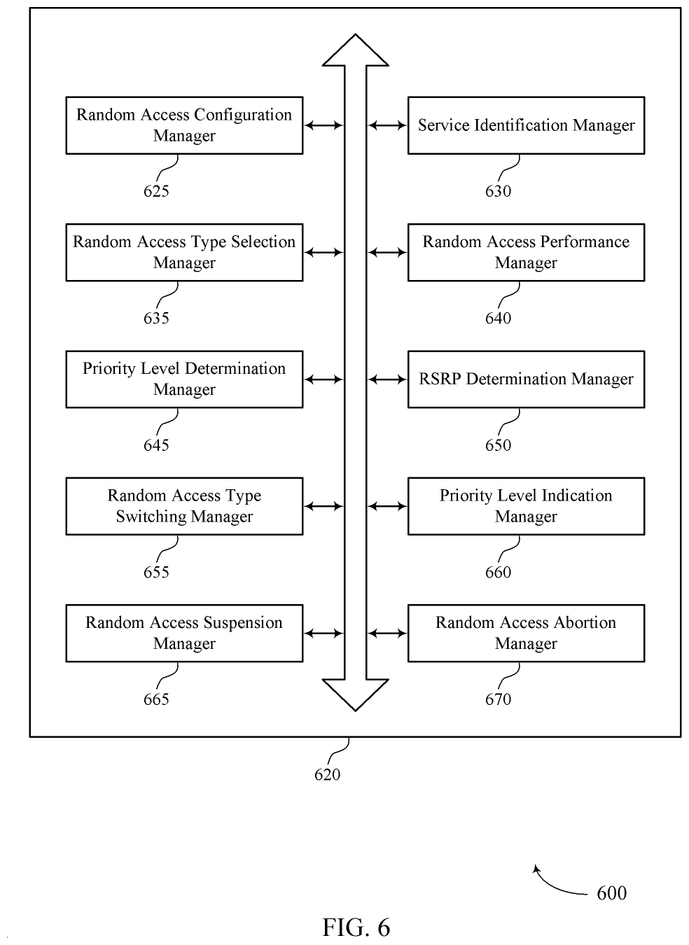

FIG. 6 shows a block diagram 600 of a communications manager 620 that supports techniques for selecting a slice-based random access procedure in accordance with aspects of the present disclosure. The communications manager 620 may be an example of aspects of a communications manager 420, a communications manager 520, or both, as described herein. The communications manager 620, or various components thereof, may be an example of means for performing various aspects of techniques for selecting a slice-based random access procedure as described herein. For example, the communications manager 620 may include a random access configuration manager 625, a service identification manager 630, a random access type selection manager 635, a random access performance manager 640, a priority level determination manager 645, an RSRP determination manager 650, a random access type switching manager 655, a priority level indication manager 660, a random access suspension manager 665, a random access abortion manager 670, or any combination thereof. Each of these components may communicate, directly or indirectly, with one another (e.g., via one or more buses).

The communications manager 620 may support wireless communications at a UE in accordance with examples as disclosed herein. The random access configuration manager 625 may be configured as or otherwise support a means for receiving, from a base station, a random access configuration for performance, by the UE, of random access with a physical network. The service identification manager 630 may be configured as or otherwise support a means for identifying a service to be accessed by the UE, the service supported by a logical network associated with the physical network. The random access type selection manager 635 may be configured as or otherwise support a means for selecting a service-based random access procedure type based on the random access configuration and the service to be accessed by the UE. The random access performance manager 640 may be configured as or otherwise support a means for performing a service-based random access procedure in accordance with the service-based random access procedure type.

In some examples, the service supported by the logical network associated with the physical network is a network slice. In some examples, the service-based random access procedure type is a slice-based random access procedure type and the service-based random access procedure is a slice-based random access procedure.

In some examples, to support receiving the random access configuration, the random access configuration manager 625 may be configured as or otherwise support a means for receiving an indication that the network slice is associated with a priority level, where selection of the slice-based random access procedure type is based on the priority level of the network slice.

In some examples, to support selecting the slice-based random access procedure type, the priority level determination manager 645 may be configured as or otherwise support a means for determining that the priority level is greater than a threshold priority level. In some examples, to support selecting the slice-based random access procedure type, the random access type selection manager 635 may be configured as or otherwise support a means for selecting a two-step slice-based random access procedure as the slice-based random access procedure type based on the priority level being greater than the threshold priority level.

In some examples, to support selecting the slice-based random access procedure type, the priority level determination manager 645 may be configured as or otherwise support a means for determining that the priority level is less than a threshold priority level. In some examples, to support selecting the slice-based random access procedure type, the random access type selection manager 635 may be configured as or otherwise support a means for selecting a four-step slide-based random access procedure as the slice-based random access procedure type based on the priority level being less than the threshold priority level.

In some examples, to support receiving the random access configuration, the random access configuration manager 625 may be configured as or otherwise support a means for receiving an indication that the network slice is associated with a priority level and that the priority level is associated with a reference signal received power threshold, where selection of the slice-based random access procedure type is based on the priority level of the network slice and satisfaction of the reference signal received power threshold.

In some examples, to support selecting the slice-based random access procedure type, the RSRP determination manager 650 may be configured as or otherwise support a means for determining that a measured reference signal received power is greater than the reference signal received power threshold. In some examples, to support selecting the slice-based random access procedure type, the random access type selection manager 635 may be configured as or otherwise support a means for selecting a two-step slice-based random access procedure as the slice-based random access procedure type based on the measured reference signal received power being greater than the reference signal received power threshold.

In some examples, to support selecting the slice-based random access procedure type, the RSRP determination manager 650 may be configured as or otherwise support a means for determining that a measured reference signal received power is less than the reference signal received power threshold. In some examples, to support selecting the slice-based random access procedure type, the random access type selection manager 635 may be configured as or otherwise support a means for selecting a four-step slice-based random access procedure as the slice-based random access procedure type based on the measured reference signal received power being less than the reference signal received power threshold. In some examples, the priority level is greater than a threshold priority level.

In some examples, to support receiving the random access configuration, the random access configuration manager 625 may be configured as or otherwise support a means for receiving an indication of a first random access procedure threshold for attempting random access with the physical network using the slice-based random access procedure type.

In some examples, the first random access procedure threshold is a duration of time. In some examples, the first random access procedure threshold is a number of attempts.

In some examples, the random access performance manager 640 may be configured as or otherwise support a means for attempting to perform the slice-based random access procedure until the first random access procedure threshold is satisfied. In some examples, the random access type switching manager 655 may be configured as or otherwise support a means for switching to a common random access procedure based at least in part on satisfaction of the first random access procedure threshold.

In some examples, the UE switches to a two-step common random access procedure based on the slice-based random access procedure type being a two-step slice-based random access procedure. In some examples, the UE switches to a four-step common random access procedure based on the slice-based random access procedure type being a four-step slice-based random access procedure.

In some examples, to support receiving the random access configuration, the random access configuration manager 625 may be configured as or otherwise support a means for receiving an indication of a second random access procedure threshold associated with a second slice-based random access procedure type, the slice-based random access procedure type being a first slice-based random access procedure type different from the second slice-based random access procedure type.

In some examples, the random access performance manager 640 may be configured as or otherwise support a means for attempting to perform random access with the physical network using the first slice-based random access procedure type until satisfaction of the first random access procedure threshold. In some examples, the random access type switching manager 655 may be configured as or otherwise support a means for switching to use of the second slice-based random access procedure type for random access based on satisfaction of the first random access procedure threshold without successful random access using the first slice-based random access procedure type. In some examples, the random access performance manager 640 may be configured as or otherwise support a means for attempting to perform random access with the physical network using the second slice-based random access procedure type until satisfaction of the second random access procedure threshold. In some examples, the random access type switching manager 655 may be configured as or otherwise support a means for switching to use of a four-step common random access procedure type for random access based on satisfaction of the second random access procedure threshold without successful random access using the second slice-based random access procedure type, where the first slice-based random access procedure type is a two-step slice-based random access procedure type and the second slice-based random access procedure type is a four-step slice-based random access procedure type.

In some examples, to support receiving the random access configuration, the random access configuration manager 625 may be configured as or otherwise support a means for receiving an indication of a second random access procedure threshold associated with a second slice-based random access procedure type and a third random access procedure threshold associated with a two-step common random access procedure type, the slice-based random access procedure type being a first slice-based random access procedure type different from the second slice-based random access procedure type.

In some examples, the random access performance manager 640 may be configured as or otherwise support a means for attempting to perform random access with the physical network using the first slice-based random access procedure type until satisfaction of the first random access procedure threshold. In some examples, the random access type switching manager 655 may be configured as or otherwise support a means for switching to use of the second slice-based random access procedure type for random access based on satisfaction of the first random access procedure threshold without successful random access using the first slice-based random access procedure type. In some examples, the random access performance manager 640 may be configured as or otherwise support a means for attempting to perform random access with the physical network using the second slice-based random access procedure type until satisfaction of the second random access procedure threshold. In some examples, the random access type switching manager 655 may be configured as or otherwise support a means for switching to use of the two-step common random access procedure type based on satisfaction of the second random access procedure threshold without successful random access using the second slice-based random access procedure type. In some examples, the random access performance manager 640 may be configured as or otherwise support a means for attempting to perform random access with the physical network using the two-step common random access procedure type until satisfaction of the third random access procedure threshold. In some examples, the random access type switching manager 655 may be configured as or otherwise support a means for switching to use of a four-step common random access procedure type for random access based on satisfaction of the third random access procedure threshold without successful random access using the two-step common random access procedure type, where the first slice-based random access procedure type is a two-step slice-based random access procedure type and the second slice-based random access procedure type is a four-step slice-based random access procedure type.

In some examples, to support receiving the random access configuration, the random access configuration manager 625 may be configured as or otherwise support a means for receiving an indication of a second random access procedure threshold associated with a two-step common random access procedure type.

In some examples, the random access performance manager 640 may be configured as or otherwise support a means for attempting to perform random access with the physical network using the slice-based random access procedure type until satisfaction of the first random access procedure threshold. In some examples, the random access type switching manager 655 may be configured as or otherwise support a means for switching to use of the two-step common random access procedure type based on satisfaction of the first random access procedure threshold without successful random access using the slice-based random access procedure type. In some examples, the random access performance manager 640 may be configured as or otherwise support a means for attempting to perform random access with the physical network using the two-step common random access procedure type until satisfaction of the second random access procedure threshold. In some examples, the random access type switching manager 655 may be configured as or otherwise support a means for switching to use of a four-step common random access procedure type for random access based on satisfaction of the second random access procedure threshold without successful random access using the two-step common random access procedure type, where the slice-based random access procedure type is a four-step slice-based random access procedure type.

In some examples, the service identification manager 630 may be configured as or otherwise support a means for identifying a second network slice to be accessed by the UE via a second slice-based random access procedure, where the slice-based random access procedure is a first slice-based random access procedure that is different from the second slice-based random access procedure, and the network slice is a first network slice that is different from the second network slice.

In some examples, the priority level indication manager 660 may be configured as or otherwise support a means for receiving an indication that the first network slice is associated with a first priority level and the second network slice is associated with a second priority level.

In some examples, the priority level determination manager 645 may be configured as or otherwise support a means for determining that the first network slice is of higher priority than the second network slice. In some examples, the random access suspension manager 665 may be configured as or otherwise support a means for suspending the second slice-based random access procedure based on the first network slice having higher priority than the second network slice.

In some examples, the priority level determination manager 645 may be configured as or otherwise support a means for determining that the second network slice is of higher priority than the first network slice. In some examples, the random access abortion manager 670 may be configured as or otherwise support a means for aborting the first slice-based random access procedure based on the second network slice having higher priority than the first network slice. In some examples, the random access performance manager 640 may be configured as or otherwise support a means for performing the second slice-based random access procedure in place of the first slice-based random access procedure.

In some examples, the random access suspension manager 665 may be configured as or otherwise support a means for suspending the second slice-based random access procedure based on the first slice-based random access procedure already being in progress.

In some examples, to support receiving the random access configuration, the random access configuration manager 625 may be configured as or otherwise support a means for receiving at least a portion of the random access configuration in a system information block message.

In some examples, to support receiving the random access configuration, the random access configuration manager 625 may be configured as or otherwise support a means for receiving at least a portion of the random access configuration in a radio resource control message.

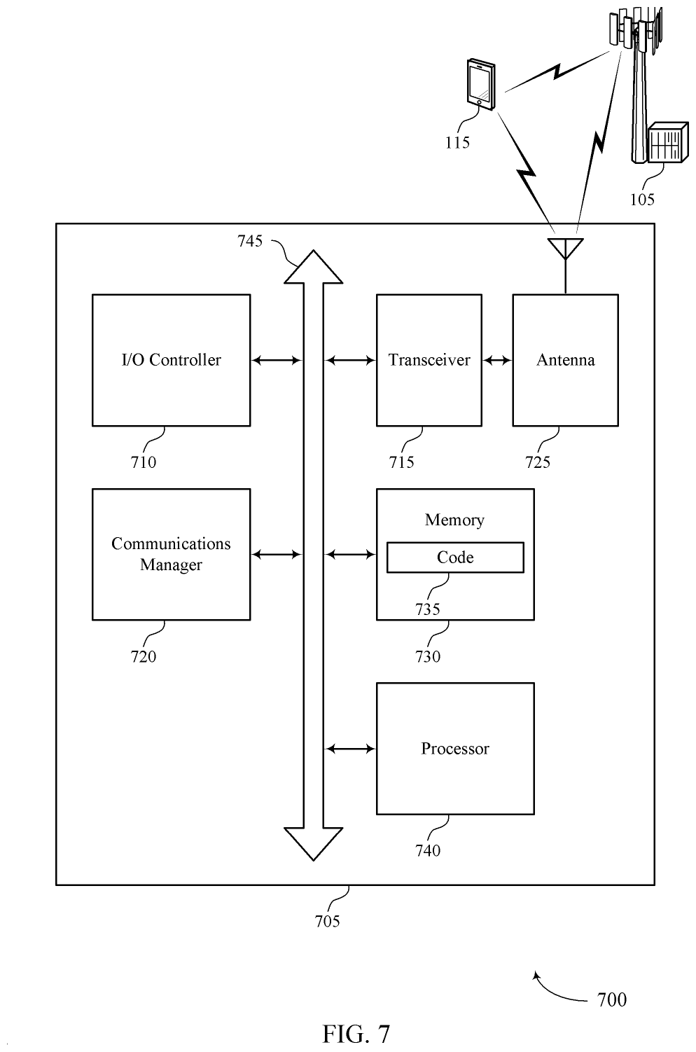

FIG. 7 shows a diagram of a system 700 including a device 705 that supports techniques for selecting a slice-based random access procedure in accordance with aspects of the present disclosure. The device 705 may be an example of or include the components of a device 405, a device 505, or a UE 115 as described herein. The device 705 may communicate wirelessly with one or more base stations 105, UEs 115, or any combination thereof. The device 705 may include components for bi-directional voice and data communications including components for transmitting and receiving communications, such as a communications manager 720, an input/output (I/O) controller 710, a transceiver 715, an antenna 725, a memory 730, code 735, and a processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally or alternatively, the I/O controller 710 may represent or interact with a modem, a keyboard, a mouse, a touchscreen, or a similar device. In some cases, the I/O controller 710 may be implemented as part of a processor, such as the processor 740. In some cases, a user may interact with the device 705 via the I/O controller 710 or via hardware components controlled by the I/O controller 710.

In some cases, the device 705 may include a single antenna 725. However, in some other cases, the device 705 may have more than one antenna 725, which may be capable of concurrently transmitting or receiving multiple wireless transmissions. The transceiver 715 may communicate bi-directionally, via the one or more antennas 725, wired, or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The memory 730 may include random access memory (RAM) and read-only memory (ROM). The memory 730 may store computer-readable, computer-executable code 735 including instructions that, when executed by the processor 740, cause the device 705 to perform various functions described herein. The code 735 may be stored in a non-transitory computer-readable medium such as system memory or another type of memory. In some cases, the code 735 may not be directly executable by the processor 740 but may cause a computer (e.g., when compiled and executed) to perform functions described herein. In some cases, the memory 730 may contain, among other things, a basic I/O system (BIOS) which may control basic hardware or software operation such as the interaction with peripheral components or devices.

The processor 740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In some other cases, a memory controller may be integrated into the processor 740. The processor 740 may be configured to execute computer-readable instructions stored in a memory (e.g., the memory 730) to cause the device 705 to perform various functions (e.g., functions or tasks supporting techniques for selecting a slice-based random access procedure). For example, the device 705 or a component of the device 705 may include a processor 740 and memory 730 coupled to the processor 740, the processor 740 and memory 730 configured to perform various functions described herein.

The communications manager 720 may support wireless communications at a UE in accordance with examples as disclosed herein. For example, the communications manager 720 may be configured as or otherwise support a means for receiving, from a base station, a random access configuration for performance, by the UE, of random access with a physical network. The communications manager 720 may be configured as or otherwise support a means for identifying a service to be accessed by the UE, the service supported by a logical network associated with the physical network. The communications manager 720 may be configured as or otherwise support a means for selecting a service-based random access procedure type based on the random access configuration and the service to be accessed by the UE. The communications manager 720 may be configured as or otherwise support a means for performing a service-based random access procedure in accordance with the service-based random access procedure type.

By including or configuring the communications manager 720 in accordance with examples as described herein, the device 705 may support techniques for improved communication reliability, reduced latency, and improved coordination between devices.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the processor 740, the memory 730, the code 735, or any combination thereof. For example, the code 735 may include instructions executable by the processor 740 to cause the device 705 to perform various aspects of techniques for selecting a slice-based random access procedure as described herein, or the processor 740 and the memory 730 may be otherwise configured to perform or support such operations.

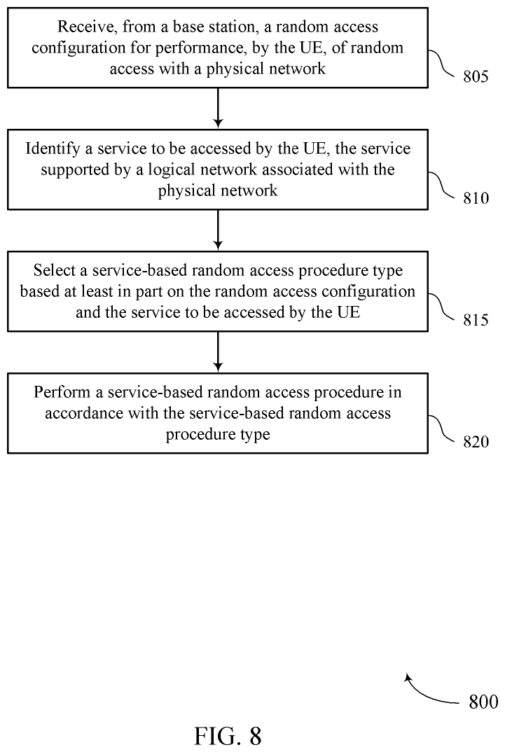

FIG. 8 shows a flowchart illustrating a method 800 that supports techniques for selecting a slice-based random access procedure in accordance with aspects of the present disclosure. The operations of the method 800 may be implemented by a UE or its components as described herein. For example, the operations of the method 800 may be performed by a UE 115 as described with reference to FIGS. 1 through 7. In some examples, a UE may execute a set of instructions to control the functional elements of the UE to perform the described functions. Additionally or alternatively, the UE may perform aspects of the described functions using special-purpose hardware.

At 805, the method may include receiving, from a base station, a random access configuration for performance, by the UE, of random access with a physical network. The operations of 805 may be performed in accordance with examples as disclosed herein. In some examples, aspects of the operations of 805 may be performed by a random access configuration manager 625 as described with reference to FIG. 6.

At 810, the method may include identifying a service to be accessed by the UE, the service supported by a logical network associated with the physical network. The operations of 810 may be performed in accordance with examples as disclosed herein. In some examples, aspects of the operations of 810 may be performed by a service identification manager 630 as described with reference to FIG. 6.

At 815, the method may include selecting a service-based random access procedure type based on the random access configuration and the service to be accessed by the UE. The operations of 815 may be performed in accordance with examples as disclosed herein. In some examples, aspects of the operations of 815 may be performed by a random access type selection manager 635 as described with reference to FIG. 6.

At 820, the method may include performing a service-based random access procedure in accordance with the service-based random access procedure type. The operations of 820 may be performed in accordance with examples as disclosed herein. In some examples, aspects of the operations of 820 may be performed by a random access performance manager 640 as described with reference to FIG. 6.

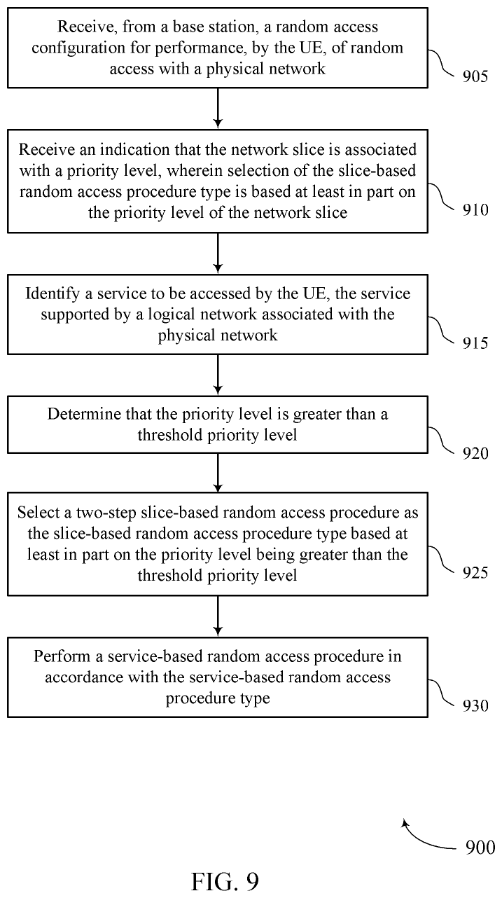

FIG. 9 shows a flowchart illustrating a method 900 that supports techniques for selecting a slice-based random access procedure in accordance with aspects of the present disclosure. The operations of the method 900 may be implemented by a UE or its components as described herein. For example, the operations of the method 900 may be performed by a UE 115 as described with reference to FIGS. 1 through 7. In some examples, a UE may execute a set of instructions to control the functional elements of the UE to perform the described functions. Additionally or alternatively, the UE may perform aspects of the described functions using special-purpose hardware.

At 905, the method may include receiving, from a base station, a random access configuration for performance, by the UE, of random access with a physical network. The operations of 905 may be performed in accordance with examples as disclosed herein. In some examples, aspects of the operations of 905 may be performed by a random access configuration manager 625 as described with reference to FIG. 6.

At 910, the method may include receiving an indication that the network slice is associated with a priority level, where selection of the slice-based random access procedure type is based on the priority level of the network slice. The operations of 910 may be performed in accordance with examples as disclosed herein. In some examples, aspects of the operations of 910 may be performed by a random access configuration manager 625 as described with reference to FIG. 6.

At 915, the method may include identifying a service to be accessed by the UE, the service supported by a logical network associated with the physical network. The operations of 915 may be performed in accordance with examples as disclosed herein. In some examples, aspects of the operations of 915 may be performed by a service identification manager 630 as described with reference to FIG. 6.

At 920, the method may include determining that the priority level is greater than a threshold priority level. The operations of 920 may be performed in accordance with examples as disclosed herein. In some examples, aspects of the operations of 920 may be performed by a priority level determination manager 645 as described with reference to FIG. 6.

At 925, the method may include selecting a two-step slice-based random access procedure as the slice-based random access procedure type based on the priority level being greater than the threshold priority level. The operations of 925 may be performed in accordance with examples as disclosed herein. In some examples, aspects of the operations of 925 may be performed by a random access type selection manager 635 as described with reference to FIG. 6.

At 930, the method may include performing a service-based random access procedure in accordance with the service-based random access procedure type. The operations of 930 may be performed in accordance with examples as disclosed herein. In some examples, aspects of the operations of 930 may be performed by a random access performance manager 640 as described with reference to FIG. 6.

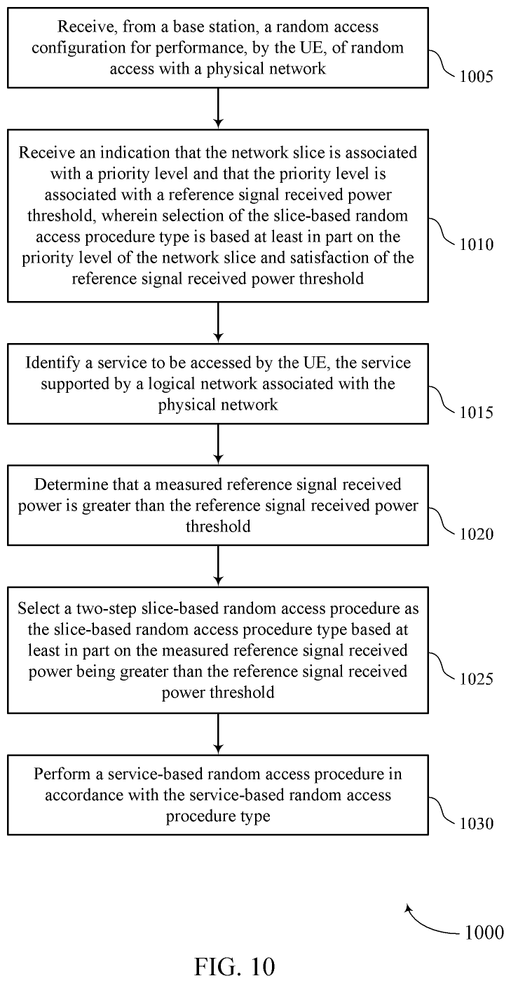

FIG. 10 shows a flowchart illustrating a method 1000 that supports techniques for selecting a slice-based random access procedure in accordance with aspects of the present disclosure. The operations of the method 1000 may be implemented by a UE or its components as described herein. For example, the operations of the method 1000 may be performed by a UE 115 as described with reference to FIGS. 1 through 7. In some examples, a UE may execute a set of instructions to control the functional elements of the UE to perform the described functions. Additionally or alternatively, the UE may perform aspects of the described functions using special-purpose hardware.

At 1005, the method may include receiving, from a base station, a random access configuration for performance, by the UE, of random access with a physical network. The operations of 1005 may be performed in accordance with examples as disclosed herein. In some examples, aspects of the operations of 1005 may be performed by a random access configuration manager 625 as described with reference to FIG. 6.

At 1010, the method may include receiving an indication that the network slice is associated with a priority level and that the priority level is associated with a reference signal received power threshold, where selection of the slice-based random access procedure type is based on the priority level of the network slice and satisfaction of the reference signal received power threshold. The operations of 1010 may be performed in accordance with examples as disclosed herein. In some examples, aspects of the operations of 1010 may be performed by a random access configuration manager 625 as described with reference to FIG. 6.

At 1015, the method may include identifying a service to be accessed by the UE, the service supported by a logical network associated with the physical network. The operations of 1015 may be performed in accordance with examples as disclosed herein. In some examples, aspects of the operations of 1015 may be performed by a service identification manager 630 as described with reference to FIG. 6.

At 1020, the method may include determining that a measured reference signal received power is greater than the reference signal received power threshold. The operations of 1020 may be performed in accordance with examples as disclosed herein. In some examples, aspects of the operations of 1020 may be performed by an RSRP determination manager 650 as described with reference to FIG. 6.

At 1025, the method may include selecting a two-step slice-based random access procedure as the slice-based random access procedure type based on the measured reference signal received power being greater than the reference signal received power threshold. The operations of 1025 may be performed in accordance with examples as disclosed herein. In some examples, aspects of the operations of 1025 may be performed by a random access type selection manager 635 as described with reference to FIG. 6.

At 1030, the method may include performing a service-based random access procedure in accordance with the service-based random access procedure type. The operations of 1030 may be performed in accordance with examples as disclosed herein. In some examples, aspects of the operations of 1030 may be performed by a random access performance manager 640 as described with reference to FIG. 6.

The following provides an overview of aspects of the present disclosure:

Aspect 1: A method for wireless communications at a UE, comprising: receiving, from a base station, a random access configuration for performance, by the UE, of random access with a physical network; identifying a service to be accessed by the UE, the service supported by a logical network associated with the physical network; selecting a service-based random access procedure type based at least in part on the random access configuration and the service to be accessed by the UE; and performing a service-based random access procedure in accordance with the service-based random access procedure type.

Aspect 2: The method of aspect 1, wherein the service supported by the logical network associated with the physical network is a network slice, and the service-based random access procedure type is a slice-based random access procedure type and the service-based random access procedure is a slice-based random access procedure.

Aspect 3: The method of aspect 2, wherein receiving the random access configuration comprises: receiving an indication that the network slice is associated with a priority level, wherein selection of the slice-based random access procedure type is based at least in part on the priority level of the network slice.

Aspect 4: The method of aspect 3, wherein selecting the slice-based random access procedure type further comprises: determining that the priority level is greater than a threshold priority level; and selecting a two-step slice-based random access procedure as the slice-based random access procedure type based at least in part on the priority level being greater than the threshold priority level.

Aspect 5: The method of any of aspects 3 through 4, wherein selecting the slice-based random access procedure type further comprises: determining that the priority level is less than a threshold priority level; and selecting a four-step slide-based random access procedure as the slice-based random access procedure type based at least in part on the priority level being less than the threshold priority level.

Aspect 6: The method of any of aspects 2 through 5, wherein receiving the random access configuration comprises: receiving an indication that the network slice is associated with a priority level and that the priority level is associated with a reference signal received power threshold, wherein selection of the slice-based random access procedure type is based at least in part on the priority level of the network slice and satisfaction of the reference signal received power threshold.

Aspect 7: The method of aspect 6, wherein selecting the slice-based random access procedure type further comprises: determining that a measured reference signal received power is greater than the reference signal received power threshold; and selecting a two-step slice-based random access procedure as the slice-based random access procedure type based at least in part on the measured reference signal received power being greater than the reference signal received power threshold.

Aspect 8: The method of aspect 6, wherein selecting the slice-based random access procedure type further comprises: determining that a measured reference signal received power is less than the reference signal received power threshold; and selecting a four-step slice-based random access procedure as the slice-based random access procedure type based at least in part on the measured reference signal received power being less than the reference signal received power threshold.

Aspect 9: The method of any of aspects 6 through 8, wherein the priority level is greater than a threshold priority level.

Aspect 10: The method of any of aspects 2 through 9, wherein receiving the random access configuration comprises: receiving an indication of a first random access procedure threshold for attempting random access with the physical network using the slice-based random access procedure type.

Aspect 11: The method of aspect 10, wherein the first random access procedure threshold is a duration of time.

Aspect 12: The method of aspect 10, wherein the first random access procedure threshold is a number of attempts.

Aspect 13: The method of any of aspects 10 through 12, further comprising: attempting to perform the slice-based random access procedure until the first random access procedure threshold is satisfied; and switching to a common random access procedure based at least in part on satisfaction of the first random access procedure threshold.

Aspect 14: The method of aspect 13, wherein the UE switches to a two-step common random access procedure based at least in part on the slice-based random access procedure type being a two-step slice-based random access procedure.

Aspect 15: The method of aspect 13, wherein the UE switches to a four-step common random access procedure based at least in part on the slice-based random access procedure type being a four-step slice-based random access procedure.

Aspect 16: The method of any of aspects 10 through 15, wherein receiving the random access configuration comprises: receiving an indication of a second random access procedure threshold associated with a second slice-based random access procedure type, the slice-based random access procedure type being a first slice-based random access procedure type different from the second slice-based random access procedure type.

Aspect 17: The method of aspect 16, further comprising: attempting to perform random access with the physical network using the first slice-based random access procedure type until satisfaction of the first random access procedure threshold; switching to use of the second slice-based random access procedure type for random access based at least in part on satisfaction of the first random access procedure threshold without successful random access using the first slice-based random access procedure type; attempting to perform random access with the physical network using the second slice-based random access procedure type until satisfaction of the second random access procedure threshold; and switching to use of a four-step common random access procedure type for random access based at least in part on satisfaction of the second random access procedure threshold without successful random access using the second slice-based random access procedure type, wherein the first slice-based random access procedure type is a two-step slice-based random access procedure type and the second slice-based random access procedure type is a four-step slice-based random access procedure type.

Aspect 18: The method of any of aspects 10 through 17, wherein receiving the random access configuration comprises: receiving an indication of a second random access procedure threshold associated with a second slice-based random access procedure type and a third random access procedure threshold associated with a two-step common random access procedure type, the slice-based random access procedure type being a first slice-based random access procedure type different from the second slice-based random access procedure type.

Aspect 19: The method of aspect 18, further comprising: attempting to perform random access with the physical network using the first slice-based random access procedure type until satisfaction of the first random access procedure threshold; switching to use of the second slice-based random access procedure type for random access based at least in part on satisfaction of the first random access procedure threshold without successful random access using the first slice-based random access procedure type; attempting to perform random access with the physical network using the second slice-based random access procedure type until satisfaction of the second random access procedure threshold; switching to use of the two-step common random access procedure type based at least in part on satisfaction of the second random access procedure threshold without successful random access using the second slice-based random access procedure type; attempting to perform random access with the physical network using the two-step common random access procedure type until satisfaction of the third random access procedure threshold; and switching to use of a four-step common random access procedure type for random access based at least in part on satisfaction of the third random access procedure threshold without successful random access using the two-step common random access procedure type, wherein the first slice-based random access procedure type is a two-step slice-based random access procedure type and the second slice-based random access procedure type is a four-step slice-based random access procedure type.

Aspect 20: The method of any of aspects 10 through 19, wherein receiving the random access configuration comprises: receiving an indication of a second random access procedure threshold associated with a two-step common random access procedure type.

Aspect 21: The method of aspect 20, further comprising: attempting to perform random access with the physical network using the slice-based random access procedure type until satisfaction of the first random access procedure threshold; switching to use of the two-step common random access procedure type based at least in part on satisfaction of the first random access procedure threshold without successful random access using the slice-based random access procedure type; attempting to perform random access with the physical network using the two-step common random access procedure type until satisfaction of the second random access procedure threshold; and switching to use of a four-step common random access procedure type for random access based at least in part on satisfaction of the second random access procedure threshold without successful random access using the two-step common random access procedure type, wherein the slice-based random access procedure type is a four-step slice-based random access procedure type.

Aspect 22: The method of any of aspects 2 through 21, further comprising: identifying a second network slice to be accessed by the UE via a second slice-based random access procedure, wherein the slice-based random access procedure is a first slice-based random access procedure that is different from the second slice-based random access procedure, and the network slice is a first network slice that is different from the second network slice.

Aspect 23: The method of aspect 22, further comprising: receiving an indication that the first network slice is associated with a first priority level and the second network slice is associated with a second priority level.

Aspect 24: The method of aspect 23, further comprising: determining that the first network slice is of higher priority than the second network slice; and suspending the second slice-based random access procedure based at least in part on the first network slice having higher priority than the second network slice.

Aspect 25: The method of aspect 23, further comprising: determining that the second network slice is of higher priority than the first network slice; aborting the first slice-based random access procedure based at least in part on the second network slice having higher priority than the first network slice; and performing the second slice-based random access procedure in place of the first slice-based random access procedure.

Aspect 26: The method of any of aspects 22 through 25, further comprising: suspending the second slice-based random access procedure based at least in part on the first slice-based random access procedure already being in progress.

Aspect 27: The method of any of aspects 1 through 26, wherein receiving the random access configuration further comprises: receiving at least a portion of the random access configuration in a system information block message.

Aspect 28: The method of any of aspects 1 through 27, wherein receiving the random access configuration further comprises: receiving at least a portion of the random access configuration in a radio resource control message.

Aspect 29: An apparatus for wireless communications at a UE, comprising a processor; memory coupled with the processor; and instructions stored in the memory and executable by the processor to cause the apparatus to perform a method of any of aspects 1 through 28.

Aspect 30: An apparatus for wireless communications at a UE, comprising at least one means for performing a method of any of aspects 1 through 28.

Aspect 31: A non-transitory computer-readable medium storing code for wireless communications at a UE, the code comprising instructions executable by a processor to perform a method of any of aspects 1 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a user equipment (UE), comprising:
receiving, from a base station, a random access configuration for performance, by the UE, of random access with a physical network;
identifying a service to be accessed by the UE, the service supported by a logical network associated with the physical network;
selecting a service-based random access procedure type based at least in part on the random access configuration and the service to be accessed by the UE; and
performing a service-based random access procedure in accordance with the service-based random access procedure type.

2-28. (canceled)

29. An apparatus for wireless communications at a user equipment (UE), comprising:
a processor;
memory coupled with the processor; and
instructions stored in the memory and executable by the processor to cause the apparatus to:
receive, from a base station, a random access configuration for performance, by the UE, of random access with a physical network;
identify a service to be accessed by the UE, the service supported by a logical network associated with the physical network;
select a service-based random access procedure type based at least in part on the random access configuration and the service to be accessed by the UE; and
perform a service-based random access procedure in accordance with the service-based random access procedure type.

30. The apparatus of claim 29, wherein:
the service supported by the logical network associated with the physical network is a network slice, and
the service-based random access procedure type is a slice-based random access procedure type and the service-based random access procedure is a slice-based random access procedure.

31. The apparatus of claim 30, wherein the instructions to receive the random access configuration are executable by the processor to cause the apparatus to:
receive an indication that the network slice is associated with a priority level, wherein selection of the slice-based random access procedure type is based at least in part on the priority level of the network slice.

32. The apparatus of claim 31, wherein the instructions to select the slice-based random access procedure type are further executable by the processor to cause the apparatus to:
determine that the priority level is greater than a threshold priority level; and
select a two-step slice-based random access procedure as the slice-based random access procedure type based at least in part on the priority level being greater than the threshold priority level.

33. The apparatus of claim 31, wherein the instructions to select the slice-based random access procedure type are further executable by the processor to cause the apparatus to:
determine that the priority level is less than a threshold priority level; and
select a four-step slide-based random access procedure as the slice-based random access procedure type based at least in part on the priority level being less than the threshold priority level.

34. The apparatus of claim 30, wherein the instructions to receive the random access configuration are executable by the processor to cause the apparatus to:
receive an indication that the network slice is associated with a priority level and that the priority level is associated with a reference signal received power threshold, wherein selection of the slice-based random access procedure type is based at least in part on the priority level of the network slice and satisfaction of the reference signal received power threshold.

35. The apparatus of claim 34, wherein the instructions to select the slice-based random access procedure type are further executable by the processor to cause the apparatus to:
determine that a measured reference signal received power is greater than the reference signal received power threshold; and
select a two-step slice-based random access procedure as the slice-based random access procedure type based at least in part on the measured reference signal received power being greater than the reference signal received power threshold.

36. The apparatus of claim 34, wherein the instructions to select the slice-based random access procedure type are further executable by the processor to cause the apparatus to:
determine that a measured reference signal received power is less than the reference signal received power threshold; and
select a four-step slice-based random access procedure as the slice-based random access procedure type based at least in part on the measured reference signal received power being less than the reference signal received power threshold.

37. The apparatus of claim 34, wherein the priority level is greater than a threshold priority level.

38. The apparatus of claim 30, wherein the instructions to receive the random access configuration are executable by the processor to cause the apparatus to:
receive an indication of a first random access procedure threshold for attempting random access with the physical network using the slice-based random access procedure type.

39. The apparatus of claim 38, wherein the first random access procedure threshold is a duration of time.

40. The apparatus of claim 38, wherein the first random access procedure threshold is a number of attempts.

41. The apparatus of claim 38, wherein the instructions are further executable by the processor to cause the apparatus to:
attempt to perform the slice-based random access procedure until the first random access procedure threshold is satisfied; and
switch to a common random access procedure based at least in part on satisfaction of the first random access procedure threshold.

42. The apparatus of claim 41, wherein the UE switches to a two-step common random access procedure based at least in part on the slice-based random access procedure type being a two-step slice-based random access procedure.

43. The apparatus of claim 41, wherein the UE switches to a four-step common random access procedure based at least in part on the slice-based random access procedure type being a four-step slice-based random access procedure.

44. The apparatus of claim 38, wherein the instructions to receive the random access configuration are executable by the processor to cause the apparatus to:
receive an indication of a second random access procedure threshold associated with a second slice-based random access procedure type, the slice-based random access procedure type being a first slice-based random access procedure type different from the second slice-based random access procedure type.

45. The apparatus of claim 44, wherein the instructions are further executable by the processor to cause the apparatus to:
attempt to perform random access with the physical network using the first slice-based random access procedure type until satisfaction of the first random access procedure threshold;
switch to use of the second slice-based random access procedure type for random access based at least in part on satisfaction of the first random access procedure threshold without successful random access using the first slice-based random access procedure type;
attempt to perform random access with the physical network using the second slice-based random access procedure type until satisfaction of the second random access procedure threshold; and
switch to use of a four-step common random access procedure type for random access based at least in part on satisfaction of the second random access procedure threshold without successful random access using the second slice-based random access procedure type, wherein the first slice-based random access procedure type is a two-step slice-based random access procedure type and the second slice-based random access procedure type is a four-step slice-based random access procedure type.

46. The apparatus of claim 38, wherein the instructions to receive the random access configuration are executable by the processor to cause the apparatus to:
receive an indication of a second random access procedure threshold associated with a second slice-based random access procedure type and a third random access procedure threshold associated with a two-step common random access procedure type, the slice-based random access procedure type being a first slice-based random access procedure type different from the second slice-based random access procedure type.

47. The apparatus of claim 46, wherein the instructions are further executable by the processor to cause the apparatus to:
attempt to perform random access with the physical network using the first slice-based random access procedure type until satisfaction of the first random access procedure threshold;
switch to use of the second slice-based random access procedure type for random access based at least in part on satisfaction of the first random access procedure threshold without successful random access using the first slice-based random access procedure type;
attempt to perform random access with the physical network using the second slice-based random access procedure type until satisfaction of the second random access procedure threshold;
switch to use of the two-step common random access procedure type based at least in part on satisfaction of the second random access procedure threshold without successful random access using the second slice-based random access procedure type;
attempt to perform random access with the physical network using the two-step common random access procedure type until satisfaction of the third random access procedure threshold; and
switch to use of a four-step common random access procedure type for random access based at least in part on satisfaction of the third random access procedure threshold without successful random access using the two-step common random access procedure type, wherein the first slice-based random access procedure type is a two-step slice-based random access procedure type and the second slice-based random access procedure type is a four-step slice-based random access procedure type.

48. The apparatus of claim 38, wherein the instructions to receive the random access configuration are executable by the processor to cause the apparatus to:
receive an indication of a second random access procedure threshold associated with a two-step common random access procedure type.

49. The apparatus of claim 48, wherein the instructions are further executable by the processor to cause the apparatus to:
attempt to perform random access with the physical network using the slice-based random access procedure type until satisfaction of the first random access procedure threshold;
switch to use of the two-step common random access procedure type based at least in part on satisfaction of the first random access procedure threshold without successful random access using the slice-based random access procedure type;
attempt to perform random access with the physical network using the two-step common random access procedure type until satisfaction of the second random access procedure threshold; and
switch to use of a four-step common random access procedure type for random access based at least in part on satisfaction of the second random access procedure threshold without successful random access using the two-step common random access procedure type, wherein the slice-based random access procedure type is a four-step slice-based random access procedure type.

50. The apparatus of claim 30, wherein the instructions are further executable by the processor to cause the apparatus to:
identify a second network slice to be accessed by the UE via a second slice-based random access procedure, wherein the slice-based random access procedure is a first slice-based random access procedure that is different from the second slice-based random access procedure, and the network slice is a first network slice that is different from the second network slice.

51. The apparatus of claim 50, wherein the instructions are further executable by the processor to cause the apparatus to:
receive an indication that the first network slice is associated with a first priority level and the second network slice is associated with a second priority level.

52. The apparatus of claim 51, wherein the instructions are further executable by the processor to cause the apparatus to:
determine that the first network slice is of higher priority than the second network slice; and
suspend the second slice-based random access procedure based at least in part on the first network slice having higher priority than the second network slice.

53. The apparatus of claim 51, wherein the instructions are further executable by the processor to cause the apparatus to:
determine that the second network slice is of higher priority than the first network slice;
abort the first slice-based random access procedure based at least in part on the second network slice having higher priority than the first network slice; and
perform the second slice-based random access procedure in place of the first slice-based random access procedure.

54. The apparatus of claim 50, wherein the instructions are further executable by the processor to cause the apparatus to:
suspend the second slice-based random access procedure based at least in part on the first slice-based random access procedure already being in progress.

55. The apparatus of claim 29, wherein the instructions to receive the random access configuration are further executable by the processor to cause the apparatus to:
receive at least a portion of the random access configuration in a system information block message.

56. The apparatus of claim 29, wherein the instructions to receive the random access configuration are further executable by the processor to cause the apparatus to:
receive at least a portion of the random access configuration in a radio resource control message.

57. An apparatus for wireless communications at a user equipment (UE), comprising:
means for receiving, from a base station, a random access configuration for performance, by the UE, of random access with a physical network;
means for identifying a service to be accessed by the UE, the service supported by a logical network associated with the physical network;
means for selecting a service-based random access procedure type based at least in part on the random access configuration and the service to be accessed by the UE; and
means for performing a service-based random access procedure in accordance with the service-based random access procedure type.

58. A non-transitory computer-readable medium storing code for wireless communications at a user equipment (UE), the code comprising instructions executable by a processor to:
receive, from a base station, a random access configuration for performance, by the UE, of random access with a physical network;
identify a service to be accessed by the UE, the service supported by a logical network associated with the physical network;
select a service-based random access procedure type based at least in part on the random access configuration and the service to be accessed by the UE; and
perform a service-based random access procedure in accordance with the service-based random access procedure type.

59-114. (canceled)
